(19) United States
(12) Patent Application Publication
(10) Pub. No.: US 2005/0026117 A1
(43) Pub. Date: Feb. 3, 2005

(54) System and method for the management of genomic data

(76) Inventors: Richard S Judson, Guilford, CT (US); Kenneth B Kaskin, Sparta, NJ (US); Kevin Rakin, Westport, CT (US); Gualberto Ruano, Milford, CT (US); Melisse F Shaban, Chapel Hill, NC (US); Gerald F Vovis, Cheshire, CT (US); Andreas K Windemuth, Woodbridge, CT (US)

Correspondence Address: GENAISSANCE PHARMACEUTICALS, 5 SCIENCE PARK, NEW HAVEN, CT, 06511, US

(21) Appl. No.: 10/433,700

(22) PCT Filed: Dec. 4, 2001
(86) PCT No.: PCT/US01/47017

Related U.S. Application Data
(60) Provisional application No. 60/251,201, filed on Dec. 4, 2000.

(51) Int. Cl. G09B 19/00

(52) U.S. Cl. 434/154

(57) ABSTRACT

A system and method is disclosed for managing users' genomic data, including providing and offering access to genomic-based services, routing genomic data to providers of genomic-based services, brokering financial transactions related to the management of genomic data, securing for users best prices for genomic-based services, allowing users to earn money for the use of their genomic and other data, and using genomic data for marketing and developing products in particular geographic regions or for particular populations.

### FIELD OF THE INVENTION

This invention relates to systems and methods for the management of genomic data and to the use of genomic data in developing and marketing products and services to consumers and the healthcare industry.

### BACKGROUND OF THE INVENTION

Recent advances in the understanding of the human genome portend great potential benefit to the population at large. It is known, for example, that there are genetic markers that indicate susceptibility to certain diseases. If an individual learns of such a susceptibility through genetic testing, she may be able to alter her lifestyle to prevent or delay the disease's onset, or to ameliorate its effects. Genomic analysis can also be used to allow a couple to make an informed reproductive decision, by determining the likelihood of children of that couple inheriting a genetic disease.

Genetic variation among individuals has also been found to be relevant to their responses to pharmaceuticals. Correlations have been found between certain genetic markers, such as haplotypes, and responses to drugs. If such correlations were used to produce genetic-based prescribing information, then prescriptions could be written with an individual's genetic makeup in mind. This could improve individuals' lifestyles by lessening side-effects and increasing efficacy.

Non-medical uses of genomic data have also been found. For example, certain manufacturers of candy and cosmetics have become interested in how genetic diversity accounts for people's varying perceptions of taste and smell. This has the potential of allowing a person to purchase candy that is particularly appealing to her genetically-determined sense of taste.

However, despite the great potential benefits of doing so, few individuals have taken advantage of genomic-based services.

One reason for this is the public's concern for the security and privacy of its genomic data. People fear, for example, that they could be denied employment, denied insurance, and otherwise discriminated against if the details of their genomic makeup became public.

Another reason is convenience. With emerging Internet and communications technologies, people are used to being able to get information quickly and with little inconvenience. However, genomic-based services such as genetic testing have been heretofore inconvenient to use. For example, an individual may have to travel to a distant location for a test. If several tests performed at different locations were required, an individual would likely have to give a genetic sample to each location. Similarly, genomic-based prescription information is not available to patients and medical professionals in such a way that it can be unobtrusively incorporated into the average medical office or pharmacy.

Further, genomic-based services, such as tests for disease susceptibility, can be expensive. Individuals are used to enjoying low prices for products and services due to competition and the assistance of Internet services. However, such price-lowering has not yet come to genomic-based services.

Thus, for at least these reasons, advances in genomic knowledge have fallen short of realizing their potential benefits to the population.

### SUMMARY OF THE INVENTION

In one aspect, the invention features a system and method for managing users' genomic data. Therefore, one object of the invention is to provide a system and method for providing and offering access to genomic-based services. Another object of the invention is to provide a system and method for routing genomic data to providers of genomic-based services. Still another object of the invention is to provide a system and method for brokering financial transactions related to the management of genomic data. A further object of the invention is to provide a system and method for securing a user a best price for a genomic-based service. Still another object of the invention is to provide a system and method for allowing users to earn money for the use of their genomic and other data. Still further objects of the invention are to provide a system and method for using genomic data to market a product in a geographic region of interest, and a system and method of using genomic data in developing new products to satisfy unmet demands or needs of a population.

Accordingly, in one embodiment the invention concerns a method for recruiting a new user for a genome management service, comprising obtaining a cell sample from a person, waiting a period of time, after the period of time has elapsed seeking from the person final permission to have his or her genomic data managed, analyzing at least a portion of the person's genome, and storing the resultant genomic data electronically. In a second embodiment the invention concerns a method for maintaining an individual's genomic data, comprising a data storage unit in which the individual's genomic data is stored and a self-destruct unit, which deletes the data on the device when a trigger event occurs. In a third embodiment the invention concerns a data card for maintaining an individual's genomic data, comprising a data storage unit in which the individual's genomic data is stored. In a fourth embodiment the invention concerns a method for providing product usage advice for an individual, comprising receiving the individual's genomic data, using the genomic data to consult a database or table which correlates genomic data with responses to products, and creating a report containing product usage advice for one or more products. In a fifth embodiment the invention concerns a method for producing marketing data, comprising receiving from a group of individuals their genomic data, receiving from the group of individuals data concerning their purchasing habits, determining correlations between the genomic data and the purchasing habits, and making a prediction concerning an individual's purchasing habits based on that individual's genomic data.

In another embodiment the invention concerns a method for marketing products to individuals based on their genomic data, comprising receiving from a group of individuals their genomic data, receiving from the group of individuals data concerning their purchasing habits, determining correlations between the genomic data and the purchasing habits, making a prediction concerning an individual's purchasing habits based on that individual's genomic data, and making a product suggestion. In an additional embodiment the invention concerns a method of providing an individual with lifestyle advice related to his or her genomic data, comprising using an individual's genomic data to consult a database or table which correlates genomic data with information related to the genomic data, receiving, as a result of the consultation, information related to the genomic data, and providing lifestyle advice related to the information.

In yet another embodiment, the invention concerns a method of marketing a product in a geographic region of interest, comprising obtaining information relating to correlations between users' response to the product and a haplotype profile, determining the frequency of the haplotype profile in the population living in the geographic region, and making a marketing decision for the geographic region based on the determined frequency of the haplotype profile. In yet another embodiment, the invention provides a method for developing a new product to satisfy a particular unmet demand or need of a population, comprising identifying a haplotype profile that is correlated with the unmet demand or need in the population, determining a functional cause for the correlation between the haplotype profile and the unmet need or demand, and developing a new product designed to avoid the functional cause.

In still another embodiment the invention concerns a method of providing a gaming experience to an individual based on his or her genomic data, comprising receiving the genomic data of the individual and affecting gameplay using the genomic data, whereby the individual's gaming experience is due at least in part to his or her genomic data. In a further embodiment the invention concerns a method of designing products based on an individual's genomic data, comprising obtaining the individual's genomic data and creating a design for the product based on the genomic data. In another embodiment the invention concerns a method for marketing an individual's genomic data, comprising contacting a party interested in using an individual's genomic data, negotiating with the party to determine the terms of use for the data, seeking the individual's consent to allow the party to use the data under the determined terms of use, and if consent is received, providing, under the determined terms of use, the genomic data to the party.

In still another embodiment the invention concerns a method for providing an individual with low price genomic-based services, comprising receiving from the individual or his or her representative a request for a genomic-based service, negotiating with a plurality of parties capable of providing the service in order to determine which party of the parties is willing to offer the service at a lower price than the remainder of the parties, and upon receiving the individual's or representative's consent, allowing the party which offered the lower price to perform the service. In a further embodiment the invention concerns a billing method for a genomic data managing service, comprising charging a management fee and charging a fee for each access or update of the data. In an additional embodiment the invention concerns a method for providing an individual's genomic data, comprising receiving from a party a request for an individual's genomic data, negotiating with the party to determine the terms of use for the data, seeking the individual's consent to allow the party to use the data under the determined terms of use, and, if consent is received, providing, under the determined terms of use, the genomic data to the party.

Another embodiment of the invention concerns a method for securely transmitting an individual's genomic data to a party, comprising storing an individual's genomic data on a data card and physically transporting the data card to the party. Still another embodiment of the invention concerns a method for securely transmitting an individual's genomic data to a party, comprising creating one or more data packages containing the individual's genomic data and allowing the party to download the package over a network. A further embodiment of the invention concerns a method for allowing a user to make use of his or her genomic data, comprising receiving from the user a request for an operation he or she wishes to be performed making use of his or her genomic data and performing the operation.

The scope of the invention should not be considered as being limited by these objects and embodiments. Additional aspects, objects, and embodiments will become clear upon a reading of the disclosure and the claims that follow it.

### BRIEF DESCRIPTION OF THE DRAWINGS

FIG. 1 is a schematic diagram of a system according to one embodiment of the invention.

FIG. 2 illustrates one embodiment of the process of adding a new user's genomic data to the system.

FIG. 3 illustrates one embodiment of the process of fulfilling a user's request for a service.

FIG. 4 illustrates one embodiment of the process of providing food, drug and nutritional supplement guidance.

FIG. 5 illustrates one embodiment of the process of finding a best price compensation for use of a user's genomic or other data.

FIG. 6 illustrates one embodiment of the process of securing for a user a best price for a particular service.

FIG. 7 illustrates one embodiment of the process of allowing a service provider access to a user's genomic or other data.

### DETAILED DESCRIPTION OF THE INVENTION

A. Definitions

The following definitions are used herein:

Candidate Gene—A gene which is hypothesized to be responsible for a disease, condition, or the response to a treatment, or to be correlated with one of these.

Genetic marker—A variation from a reference genomic or mitochondrial DNA sequence that occurs in at least one individual in a population. As used herein genetic markers include polymorphisms, haplotypes, haplotype pairs, DNA methylation patterns, and other types of markers that are presently known or subsequently discovered.

Genotype—An unphased 5′ to 3′ sequence of nucleotide pair(s) found at one or more polymorphic sites in a locus on a pair of homologous chromosomes in an individual.

Haplotype—A sequence of nucleotides found at one or more of the polymorphic sites in a locus in a single chromosome of an individual.

Haplotype pair—The two haplotypes found for a locus in a single individual.

Haplotype profile—A combination of one or more haplotypes (or haplotype pairs) that are correlated with a particular phenotype, including consumer purchasing habits, disease susceptibility, drug therapeutic profiles, patient compliance with prescribed or recommended dosing regimens.

Locus—A location on a chromosome or DNA molecule corresponding to a gene or a physical or phenotypic feature.

Nucleotide pair—The nucleotides found at a polymorphic site on the two copies of a chromosome from an individual.

Polymorphic site—A nucleotide position within a locus at which the nucleotide sequence varies from a reference sequence in at least one individual in a population. Sequence variations can be substitutions, insertions or deletions of one or more bases.

Polymorphism—The sequence variation observed in an individual at a polymorphic site. Polymorphisms include nucleotide substitutions, insertions, deletions and microsatellites and may, but need not, result in detectable differences in gene expression or protein function.

Polymorphism data—Information concerning one or more of the following for a specific gene: location of polymorphic sites; sequence variation at those sites; frequency of polymorphisms in one or more populations; the different genotypes and/or haplotypes determined for the gene; frequency of one or more of these genotypes and/or haplotypes in one or more populations; any known association(s) between a trait and a genotype or a haplotype for the gene.

Polymorphism Database—A collection of polymorphism data arranged in a systematic or methodical way and capable of being individually accessed by electronic or other means.

Reference Population—A group of subjects or individuals who are predicted to be representative of the genetic variation found in the general population living in a defined geographic region. In preferred embodiments, the reference population represents the genetic variation in the population at a certainty level of at least 85%, preferably at least 90%, more preferably at least 95% and even more preferably at least 99%.

Single Nucleotide Polymorphism (SNP)—A polymorphism in which a single nucleotide observed in a reference individual is replaced by a different single nucleotide in another individual.

Therapeutic Profile—A plot of the response (e.g., level of efficacy and or number of adverse events) exhibited by a group of individuals to a particular drug or therapy.

Unphased—As applied to a sequence of nucleotide pairs for two or more polymorphic sites in a locus, unphased means the combination of nucleotides present at those polymorphic sites on a single copy of the locus (i.e., located on a single DNA strand) is not known.

### B. DETAILED DESCRIPTION OF PREFERRED EMBODIMENTS

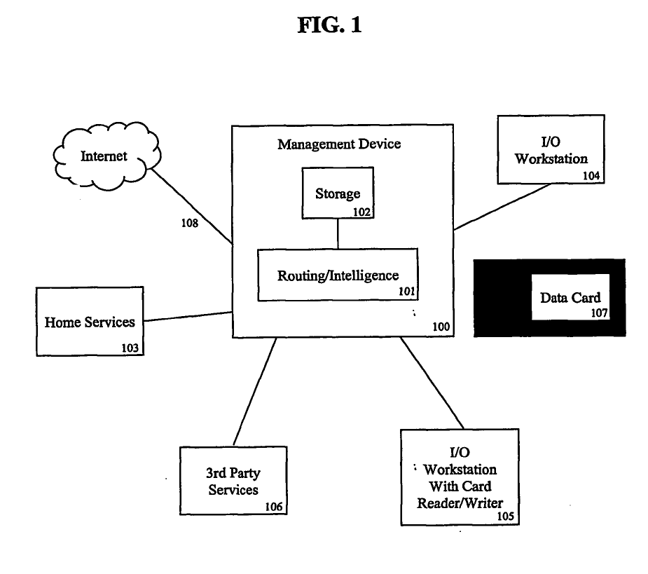

A system in accordance with an exemplary embodiment of the invention is shown in FIG. 1. A “management company”, which manages people's genomic data and/or offers them genomic-based services, could operate a management device 100. Management device 100, as shown, consists of interconnected main components storage device 102 and routing/intelligence device 101. In some embodiments, storage device 102 may be implemented using one or more secure servers or general purpose computers, while routing/intelligence device 101 may be implemented using one or more general purpose computers. In other embodiments, the functions of these two components may be combined into one component. For example, management device 100 may be implemented as one or more general purpose computers, with each computer providing the functionality of storage device 102 and/or routing/intelligence device 101. Alternately, the functionality of these two components may be spread among two or more components. The phrases “general purpose computer” and “computer,” as used herein, include, but are not limited to, an engineering workstation or PC. “General purpose computer” and “computer” also include, but are not limited to, one or more processors operatively connected to one or more memory units, wherein the memory may contain data, algorithms, and/or program code, and the processor or processors may execute the program code and/or manipulate the program code, data, and/or algorithms.

Management device 100 is connected to one or more I/O workstations 104 without data card interfaces, one or more I/O workstations with data card interfaces 105 (e.g., I/O workstations operatively connected to data card interfaces), one or more “home” genome-based services 103 provided by the management company, and optionally one or more genome-based services 106 provided by third parties. The I/O workstations equipped with card readers are capable of reading from, and in some embodiments writing to, data cards 107. These connections may be made in a variety of ways well-known in the art such as using the Internet, private lines such as leased T1 lines, or a local or areawide wireless network. In the case where private lines are used, the management device may be additionally connected to the Internet as shown in connection 108.

The I/O workstations may take several forms depending on the specific tasks they will be used for. For example, an I/O workstation used by a member to access home and third party services may be a web browsing device located in that person's home, such as a personal computer connected by the Internet. As a second example, an I/O workstation for entering a new sequence might be a browser-equipped engineering workstation connected to the Internet, further interfaced with a smart card reader/writer and laboratory equipment. As a third example, an I/O workstation in a physician's office, pharmacy, health food store, supermarket, restaurant, cyber cafe or the like might be a browser-equipped personal computer or computerized cash register connected to the Internet, further interfaced with a smart card reader. Other embodiments of I/O workstations will be obvious to those skilled in the art in light of the remainder of this disclosure and its appended claims.

The genetic material of an individual who desires or is in need of having her genomic data stored, managed or analyzed for correlations with phenotype would first need to be submitted to the management company. Genetic material may be submitted by the individual who desires genomic services, or may be submitted by a skilled intermediary, such as a physician or physician's assistant. In a preferred embodiment, this genetic material would be submitted in the form of cells obtained during a cheek swab. Although other cell and tissue samples, such as fibroblasts or blood, would provide the needed genetic material, the cheek swab has the benefit of being painless and noninvasive. In certain embodiments, specific cell types will be obtained. For example, in some embodiments it might be desired to obtain B or T cells.

There are several conditions under which the cheek cells could be obtained. In one embodiment, the patient could perform the procedure in her own home. A kit could be provided which would include instructions and the materials needed for the obtaining and shipping the sample. In a preferred embodiment, the individual comes to a collection center where the sample will be collected by trained personnel. Such a scheme has several benefits, among which are not only ensuring a properly harvested sample, but also the trained personnel being able to provide information and emotional support to the individual. This support is important because much of the general population has many questions concerning genetic information, as well as fear concerning the privacy of this data.

In order to make it easy for individuals to submit their samples, sample collection centers could be set up in a number of locations. In one embodiment, collection kiosks could be set up in public areas like malls and airports. In another embodiment, a mobile collection van could travel to certain areas where people congregate. For example, the van might park outside a busy office building at lunch time. In a third embodiment, collection could be performed at the office of a healthcare professional such as a physician.

These collection centers could be “branded.” In other words, the collection centers could have distinct colors, designs, interior layouts, exterior shapes, and the like. Such branding has several benefits, which are well known to those versed in the art. Among these are advertising, close binding of the company and its service, and establishing a corporate image. For example, designs could be chosen which make users feel that the company is “professional,” courteous, and concerned about genetic privacy. When these designs are also distinctive, customers would be able to easily tell the company apart from its competitors. Such designs would also likely stick in people's minds, hence acting as a sort of advertising.

In some embodiments, the sample would be processed as soon as possible after collection. Such an embodiment could be employed, for example, when there exists an immediate medical need to make use of an individual's genomic data. In other embodiments, a period of time would elapse between collection of the sample and its processing. For example, this period of time could be one week. The customer, or her authorized agent such as her physician, could contact the service during this period of time to have the sample destroyed or to delay further processing. If the customer did not contact the service during this period of time, the company could contact the user at the end of the period seeking permission to have the genetic sample processed. The user could choose to grant permission, deny permission, or to delay processing. If the user denied permission, or no response was received from the customer, the sample could be destroyed.

Preferably, a user who chose to delay processing could choose to do so either indefinitely or until a certain date. If the user chose to delay until a certain date, the management company would contact the user on that date seeking permission to process the sample. At this time the user would again have the choice of granting permission, denying permission, or further delaying processing. If the user choose to delay indefinitely, the management company would store the sample until it received explicit instructions to process or destroy the sample. In some embodiments, the management company would contact the user periodically, asking permission to proceed. If the user did not answer, the sample would continue to be stored but would not be processed. In other embodiments, the company would not contact the user, but instead would wait to be contacted by the user. In certain embodiments, the user would be charged a fee for the storage service. For example, the user may be charged a monthly fee if the sample is stored without being processed for more than six months. Further, the management company may impose an upper limit on how long it would be willing to store the sample without processing it. For example, the management company might set as a policy that all samples which sit unprocessed for three years are destroyed.

Many customers are reluctant to make big decisions, and might be hesitant to join the service for fear they would regret the decision later. The “waiting period” would give customers opportunity to initially submit a sample without fear, knowing that they had a period of time in which to change their mind without any consequence, with the possible exception of being charged a small processing fee.

Once the “waiting period” elapses, and final consent is given, the genetic sample provided is processed so as to yield the individual's genomic data. Such genomic data includes, but is not limited to, data relating to the individual's genes, genotype, genomic sequence or a portion thereof, haplotypes or haplotype pairs, the data describing one or more of the individual's polymorphisms, such as SNPs and RFLPs, data describing B or T cell DNA rearrangements, and data describing DNA modifications, such as methylation. The term “genomic data,” as used herein, also includes data from non-genomic DNA, such as data describing mitochondrial DNA. The processing may be done using conventional techniques well-known in the art. In some embodiments, individuals can either give final consent or have their consent presumed if they have not asked for the sample to be destroyed within a certain period of time. This processing may be performed by the management company or a third party under contract with the management company. The resultant genomic data can easily be stored on digital media. For example, the sequence of base pairs that makes up an individual's genomic sequence is effectively a string of characters. The system will write to a storage location such resultant genomic data corresponding to a new user. In some embodiments, the user or her authorized agent can opt to have this data deleted at a later time.

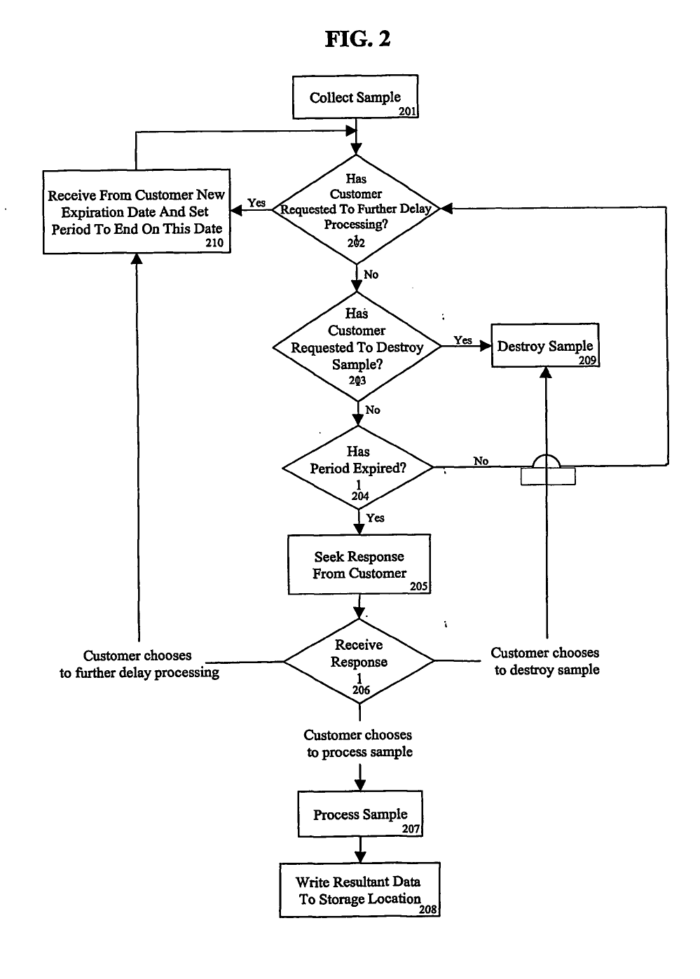

FIG. 2 is a flow chart showing one exemplary embodiment of the above-described procedure. In step 201, the sample is collected. In step 202, it is determined if the customer has requested to further delay processing. If the customer has requested to further delay processing, flow proceeds to step 210 where the new expiration date is received from the user, and the period is set to end on this date. If the customer has not requested to further delay processing, flow proceeds to 203 where it is determined if the customer has requested to destroy the sample. If it is determined that the customer has requested to destroy the sample, flow proceeds to step 209 where the sample is destroyed.

If the customer has not requested to destroy the sample, flow proceeds to step 204 where it is determined if the period has expired. If the answer is “no,” flow proceeds back to step 202. If the answer is “yes,” flow proceeds to step 205 where a response is sought from the user as to whether he or she wants to further delay processing, to process the sample, or to destroy the sample. The response is received in step 206 and depending on the response, flow proceeds to step 210 (if the customer chooses to further delay processing), 207 (if the customer chooses to process the sample), or 209 (if the customer chooses to have the sample destroyed). In step 207 the sample is processed, after which the resultant data is written to a storage location (step 208).

In a preferred embodiment the party performing the processing of the sample, whether it be a third party or employees of the management company, would not know the identity of the individual who submitted the sample. One method of achieving this is for the management company to correlate a temporary identification number with the individual. Such a temporary identification number might include numerals, letters, or other characters.

This correlation may be done by generating a semi-random temporary identification number and associating this number in a lookup table with the individual's identity. “Semi-random” refers to the fact that the randomly-generated identification number might have to meet certain requirements in order to be acceptable, and if not found to be acceptable would be regenerated. For example, the system might require that the generated number not be one which is currently in use. In other embodiments, no lookup table would be used, and the correlation would be done using a cryptographic algorithm which would translate between actual identities and temporary identification numbers. Methods for formulating such algorithms, generating such semi-random numbers, and building such lookup tables are well known to those versed in the art.

This temporary identification number, but no personally identifying information, would be included with the genetic sample for submission to the party performing the processing. This party would return the resultant genomic data, along with the corresponding temporary identification number, to the management company. In some embodiments, the party may do this by entering the information into an I/O workstation 104. The management company, upon receipt of the information, would ascertain from the returned temporary identification number which individual's genomic data had been received. This ascertaining step might be done using a lookup table. In another example, this ascertaining step might be done using a cryptographic algorithm to decode the identification number into an actual identity. Next, the genomic data would be stored and the temporary identification number would be de-correlated from the individual so that the number could be reused.

Alternately, the sample may be delivered to the party performing the processing of the sample, and the resulting genomic data may be received therefrom, in a manner according to pending application Ser. No. 09/611,654 “Methods and Apparatus for Ensuring The Privacy and Security of Personal Medical Information” (filed Jul. 7th, 2000), incorporated herein by reference. This application discloses a method of ensuring the security of data from a medical test. The method includes providing the patient with a medical data card issued by a secure information provider, and having a unique patient identification number (PID), a public key encryption private key (Key 1), and a public key encryption public key (Key 2). The medical data card is used to generate a first test request card that accompanies the test specimen taken from the patient to the secure information provider. The first test request card includes an encrypted identification of the patient and the test, a code identifying the health care provider, the patient identification number, public encryption public key (Key 2), and an identification of the test type. The secure information provider uses the first test request card to generate a second test request card to forward the patient's specimen to a testing laboratory. The second test request card and the specimen are forwarded to the laboratory. The second test request card bears an encryption of the patient's unique identification number, but does not otherwise bear any indicia that would identify the patient. The laboratory performs the prescribed test and generates a first test results card. The results, together with the patient's unique identification number, are provided to the secure information provider that issued the medical data card. The secure information provider provides the encrypted test results onto a second test results card, and forwards the card to the health care provider. The test results on the second test results card are decrypted using the patient's medical data card. The methods described in this application could be used for the non-medical uses described herein as well.

In another embodiment of the invention, the genomic services requested of the management company relate to providing therapeutic guidance to an individual, or preferably her healthcare professional (e.g., physician, pharmacist, etc), in connection with the treatment of the individual for a particular disease or condition. In this case, the individual or her healthcare professional may submit a sample for processing as described above, or alternatively, the individual or her healthcare profession may already be in possession of the genomic data that is relevant to the advice being sought and such data is submitted to the management company who would perform, or have a third party perform, the requested genomic services. The delivery of the individual's genomic data to the management company may be done by any methods for securely transmitting data that are disclosed herein, as well as by other methods known in the art.

In one embodiment, all or part of the genomic data is stored on a secure server, such as storage 102, preferably in an encrypted manner. In such a case, the genomic data that resulted from processing would be entered into or transferred to an I/O terminal 104. The data would then be routed to secure storage 102 by routing/intelligence module 101. Such routing could be achieved using signals. Secure storage 102 is managed by routing/intelligence 101 so as to carefully restrict who has access to an individual's genomic data, the guiding principle being that no one would have access to an individual's data without that individual's explicit permission. Optionally, information connecting an individual's identity to her genomic data may be separately stored, secured, and managed. In one embodiment, the genomic data would be stored in a secure database which correlated genomic data with identification numbers rather than with identities. A separate secure database, perhaps located at another location, would correlate the identification numbers with the actual identities. In another embodiment, a cryptographic algorithm would be used to translate between identification numbers and actual identities.

In another embodiment, all or part of the genomic data would reside on a data card 107 rather than on storage 102. In such a case, the genomic data that resulted from processing is entered into or transferred to an I/O terminal with data card reader/writer 105, and subsequently written to a data card 107. In certain embodiments, this would be done so that the management company would not view or posses the genomic data. For example, the party processing the sample could directly write the resultant genomic data to the data card 107. The party could than affix the temporary ID number to the outside of the card. The card would then be forwarded to the management company by secure messenger. Upon receipt of the card, the management company could, using the affixed temporary ID number, determine the user whose card has been received and forward the card to that user, perhaps by secure messenger. The management company could do this without accessing the contents of the card. In further embodiments, the party doing the processing could write the data to the card in an encrypted manner, wherein the key to unlock the data would be provided to the user but not the management company. In another embodiment, the management company could write the genomic data to the data card 107 through a secure network connection between the management company and an I/O terminal with data card reader/writer 105 located at the healthcare professional's office. In another embodiment, the data card 107 would include some or all of the individual's medical records, in particular information relating to the requested genomic services, e.g., medical history, diagnosis, clinical or physical measurements, adverse drug responses and the like. The genomic and medical information on the data card could be updated as further information becomes available.

Data card 107 would preferably be credit card sized so as to easily fit in an individual's wallet, billfold, purse, or the like. Several types of storage cards of this type exist. Among these are magnetic strip cards, “Smartcards,” flash-memory cards, and the like. Smartcards are available from numerous venders, one such vender being Siemens of Munich, Germany. Preferably, personally identifying information such as the individual's name would neither be stored on the card nor printed on its exterior.

As one example of the functionality of data card 107, a patient could go to her physician with a card encoded with her genomic data. The card could be swiped through a reader that taps into a database of drug information maintained by the management company or other service provider. The information could advise the physician which medication and/or which dose of a medication the patient should take—or avoid—for a particular illness, based on the person's genetic makeup. Alternately, the reader could be located at the patient's pharmacy and the pharmacist consults the drug information database in connection with filling a prescription written by the patient's physician. If the pharmacist receives any drug response information from the service provider that is inconsistent with the prescription, the pharmacist could communicate such information to the physician and request a revised prescription. In certain instances, the physician or pharmacist may be aware of a reason why the patient should take or avoid a particular drug. If so, that knowledge could optionally be added to the database. As researchers learn more about who is genetically likely to have a good or bad reaction to approved drugs, the database of drug information could be updated.

In another embodiment, the reader can comprise a handheld computer such as a Palm™ Handheld (manufactured by Palm Incorporated) or IPAQ™ Pocket PC (manufactured by Compaq Corporation). The physician may use the handheld device for other purposes, such as patient scheduling, accessing patient's records, taking notes, and the like. The hand-held computer may contain a database of drug information, or may be in communication with such a database operated by the management company or other service provider, either directly via a wireless connection or indirectly via a base unit station located in the physician's office or hospital. The base unit station could be connected to the database at the management company via the Internet or a private network or other type of direct link. At the end of the day, the physician may place the hand-held computer in the base unit station so that it can be recharged as well as upload data to and/or download data from the management company's database.

In a preferred embodiment, the storage card would be a smart card or a smartcard like device because of the extra features they provide. For example, smartcards have on-board processing units. Such extra features make it easier to add additional functionality to the data card. One example of such additional functionality would be a self destruct function by which the card would destroy its data under certain conditions. Examples of such conditions include the card being tampered with, an attempt to copy the card, an attempt to perform an unauthorized read of data from the card, and an attempt to perform an unauthorized write to the card. In another example, the processing unit of the card could perform encryption and decryption functions on board, a function of smart cards well-known in the art.

In another embodiment, the card could have the additional functionality of being able to operate in the manner of a credit card or bank card such that purchases could be made using the card. In still another example of additional functionality, a patient's medical record could be stored on the card, preferably in an encrypted format, in addition to her genomic data.

In an alternative embodiment, portable data storage devices other than cards can be used. For example, a touch-memory device, such as the “i-button” produced by Dallas Semiconductor of Dallas, Tex. could be used. Such touch-memory devices can be easily incorporated into objects such as jewelry. Further, the data storage device may be implemented so that it communicates wirelessly with the routing/intelligence device. Such functionality could be achieved using IEEE 802.11 wireless networking technology, as well as using other wireless communication methods well-known to those versed in the art.

Although the data card represents an alternative to storing genomic data on storage device 102, in some embodiments the user could opt to have the information on his data card “backed up” on a storage device such as storage device 102. Preferably, the data would be stored in an encrypted manner. Further, such a backup vault would preferably not be connected to public networks, such as the Internet, so as to decrease the likelihood of data theft, tampering, and manipulation.

A function of the system is to provide users easy access to services based on their genomic data. Some of these services may be provided by the management company itself (“home services” 103), others may be provided by third parties identified by or under contract with the management company, while still others could be offered by both.

In some embodiments, the user would have the option to download, receive or view her own genomic data. A user might wish to do this, for example, if she wished to do her own research on her genomic data. Further, the user may upload tests, programs, or algorithms which she wants performed or executed on her on data. For example, the user may write or execute a program which searches her genomic data for certain haplotype pairs. In another example, the user may write or execute a program which creates a musical rendition based on her genomic data.

In one embodiment, a user accessing the system through I/O workstation 104 for the purpose of using a service would be provided with menu options. This menu may take several forms, a preferred embodiment of which is a web page. An exemplary top-level menu is shown below:

Home Functions

1) Health and Life Style Advice
2) Games And Learning
3) Food, Drug and Nutritional Supplement Guidance
4) Genetic Tests
5) Participate in a Test—Medical
6) Participate in a Test—Non-medical
7) Purchase A Product based on your Genomic Data
8) Access Current Medical Information
9) Subscribe to Medical Information Updates
   Third Party Functions
1) Genetic tests
2) Participate in a Test—Medical
3) Participate in a Test—Non-medical
4) Purchase A Product Based on your Genomic Data
5) Access Current Medical Information
6) Subscribe to Medical Information Updates
   User Functions
1) View my Genomic Data
2) Receive my Genomic Data on an Encrypted Data Card, delivered by Secure Messenger
3) Download my Genomic Data to the Inserted Data Card or Other Media
4) Route my Genomic Data to a Specified Party

In such an embodiment, a user clicking on a menu option would be dropped to a lower level menu. Clicking on an option in the lower level menu might result in a still lower level menu, and so on until a final choice was chosen. For example, a user clicking on “genetic tests” would be given a choice of the available tests. After clicking on the desired test, the user would be given a menu listing providers of the test. In a preferred embodiment, prices would be listed next to each choice. Further, quality ratings may be listed next to each choice, perhaps using a rating system of one to four stars or a numerical ranking system which orders the providers based on quality. These ratings could be based on user feedback, expert evaluation, or the like.

In some embodiments, such user feedback and/or expert evaluation could be obtained by having a user and/or expert enter the feedback and/or evaluation into an I/O terminal connected to management device 100 via the Internet. For example, a user and/or expert could provide feedback and/or an evaluation by answering questions on a survey and returning it to the management company. In such embodiments routing/intelligence device 101 could route a survey from the management company to a user and/or expert's I/O terminal and, after the user and/or expert completed the survey using the I/O terminal, route the completed survey to the management company. In alternate embodiments, feedback, evaluations, and/or surveys could be transported between the management company and the expert or user using a courier. The survey would preferably include questions seeking both quantitative and qualitative information. For example, the survey could include questions concerning the accuracy of the service, as well as questions concerning whether the experience with the provider was a satisfactory one. Such a survey could be designed using methods well known in the field of surveys. For example, the survey could include alternate forms of questions which seek to obtain the same, or similar, answers. Inconsistent answers could be rejected and/or tagged for follow-up by the service provider for clarification or validation. Preferentially, the database would be updated in a manner that ensured the anonymity of the user.

In some embodiments, a quality seal of approval from a recognized authority which monitors compliance with certain standards could be listed next to providers which had been awarded the approval. In a further preferred embodiment “find the best price” and “find the provider with the highest quality rating” could be options on the menu of providers.

Upon the user selecting a provider, or a best price or quality provider being suggested to the user by the system, the system would ask the user to confirm the choice of selected or suggested provider. Preferably, this confirmation would involve the user entering a password or the like. In response to the user's confirmation, the system would route the user's genomic data to the appropriate service provider, be it the management company or a third party provider. Such routing could be achieved using signals. Depending on the service requested, the provider might require or prefer that additional information be provided in addition to the genomic data. For example, a provider who was to perform a genetic test for the user, or provide therapeutic guidance to the user's healthcare professional, might also require family history data, dietary data, medical data, lifestyle data, and the like. In such a case, the system would retrieve the required additional information and route it to the provider. In some embodiments the system would retrieve the additional information by having the user or her authorized healthcare professional enter it on her I/O terminal. In other embodiments, the system would retrieve the data from a secure database on storage unit 102. In cases where additional information is to be sent to another party, the system seeks permission from the user, and does not send the additional information to the party unless permission is granted. In certain embodiments, the additional information could be compartmentalized so that only subsets of data could be retrieved, depending on the instructions of the user.

If the chosen service provider is a third party, the routing/intelligence module 101 routes the data to the appropriate third party 106. Alternately, if the chosen service is a “home service” provided by the management company, the data is forwarded to the appropriate home service provider 103.

Once the provider completes the service, the routing/intelligence unit makes the resultant data available to the user. In one embodiment, the intelligence unit would retrieve the results from the service provider and temporarily store them on storage device 102 in an encrypted format, and the system would notify the user that the results were available. The user could then download, decrypt, and view the results the next time she logged on to the system. In some embodiments, the user would have the option of transferring the results to her data card or I/O terminal. Once the results were transferred or read, they could be deleted from the storage device 102.

In another embodiment, the system would not store the results. Instead it would notify the user that results were ready and available next time the user logged on. When the user logged on and requested the results, the intelligence module would route the results data from the provider directly to the user for reading or transfer to a data card or the like. In a preferred embodiment, the data would be routed in a secure and encrypted format. This embodiment may allay some users' fears of mishandling of their data, because the results would not even temporarily be stored on the system.

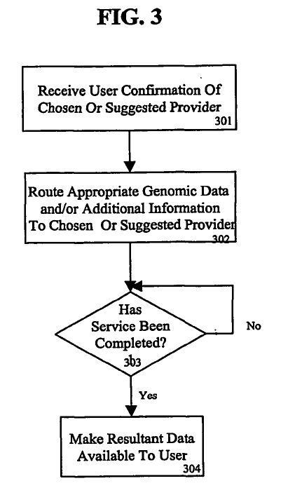

FIG. 3 is a flow chart showing one exemplary embodiment of the above-described procedure. These steps may be performed, for example, by routing/intelligence device 101. In step 301, user confirmation of the chosen or suggested provider is received. Flow then proceeds to step 302 where the appropriate genomic data and additional information is routed (or provided) to the chosen or suggested provider, and then to step 303 where it is determined if the service has been completed. If the answer is “yes,” flow proceeds to step 304 where the resultant data is made available to the user. If the answer is “no,” flow returns to step 303. In some embodiments, a provision may be made to cancel the service with the initially chosen provider and chose a new provider and route data to that new provider, for example, when the first provider is taking too long to complete the service. In such cases, the initially chosen provider's access to the data would preferably be revoked.

Notification of available results to the user could take several forms. For example, the system might flash a “results available” message the next time the user logged onto the system with an I/O terminal, or send an e-mail message. In another embodiment, the user could periodically call a telephone number to determine if her test was ready. In some embodiments, the number would connect to a live operator. In other embodiments, the number would connect to an automated voice system. In both cases, the user would preferentially have to enter a password to learn if her results were ready. In some embodiments additional security methods, such as voice print identification, may be used. In certain embodiments, the user could hear her test results via the telephone.

Alternately, the system might make a voice telephone call to the user using speech synthesis. In still another embodiment, the system might prompt a live telephone operator to call the individual and inform her that her test was ready. In some embodiments, the user would need to enter a password or to pass voice print identification before learning that a test was ready. In some embodiments, the user could choose to hear her results over the phone.

It is conceivable that in certain cases, due to illness or other factors, a user might be unable to retrieve her results and may wish to have a friend, family member, medical professional, or the like do it for her. In other cases, government regulation may require that the results be made available to a medical professional intermediary who is qualified to counsel the user as to the meaning and/or implications of the results. To provide such functionality, in some embodiments the user may specify additional parties who may access test results. A user would be able to designate such parties as being able to access the results of all tests, certain types or classes of tests, or one or more particular test instances. Further, parties may be granted conditional access. For example, a user may choose to grant her brother access to some or all of her test results, but only if she is critically ill or injured. In some embodiments, a user may choose that results could be protected using a fingerprint reader, such that results could not be accessed unless the user's finger, hand, or the like was placed in the reader. Such an embodiment could decrease the likelihood of unauthorized access to the results while, for example, allowing a physician to access results for an unconscious user by placing the user's finger, hand, or the like in the reader.

In another embodiment, the user of the system may be a medical professional, such as a physician or pharmacist, who is authorized by the patient to submit her genetic material or genomic data to the management company in connection with requesting genomic services relating to the patient's healthcare. For example, a physician or pharmacist may seek therapeutic guidance from the management company relating to which drug or dosage regimen is likely to be optimal for a particular patient based on that patients' genomic data, and preferably medical data. The physician could then choose to use the therapeutic guidance received from the management company when prescribing a drug or other therapy for the patient and the pharmacist could use such therapeutic guidance in connection with filling a prescription. In another embodiment, the user of the system is the patient's healthcare payer, e.g., insurance company or health maintenance organization (HMO), who is authorized by the patient to access the system to determine if the most cost effective therapy has been prescribed for the patient. In this case, the healthcare payer might not be able to access to the patient's genomic data and would only be able to access information relating to the efficacy and/or safety of different treatment options.

It is further conceivable that a parent might want to have tests done for her minor child, infant, fetus, or the like. In certain embodiments, the system may allow the parent to choose which parties can request tests for the child and view the results of those tests. For example, a mother would be able to decide that she and her husband, but no other parties, would have the power to request tests and view test results.

As is alluded to by the sample top level menu, many genomic-based services are made available to the user. Each of these services could potentially be offered by a third party, the management company, or both. Many of these services employ databases or tables in which genomic data (including, but not limited to, haplotypes, haplotype pairs, SNPs, or methylation patterns) and/or additional information is correlated, perhaps statistically, with phenomena such as responses to foods or medications or susceptibility to diseases. For example, a database could correlate genomic data and/or additional information with responses to medications so as to produce a therapeutic guidance model, perhaps accessible via the Internet, that could be used by a physician for prescribing purposes.

In some embodiments, functionality could be added for updating these databases, for example, by using feedback such as feedback evaluating the quality and/or accuracy of the provided service. For example, a service provider whose database correlated genomic data and responses to food might, after reporting to a user a potential reaction to a food, ask the user what her actual response was. The user's reported response, along with her genomic data and/or additional information, could be used to update the database. In some embodiments, such feedback could be obtained by having a user, expert and/or professional enter the feedback into an I/O terminal connected to management device 100 via the Internet or private network. For example, a user, expert and/or professional could provide feedback by answering questions on a survey and returning it to the management company. In such embodiments routing/intelligence device 101 could route a survey from the management company to a user, expert and/or professional's I/O terminal and, after the user, expert and/or professional completed the survey using the I/O terminal, route the completed survey to the management company. In alternate embodiments, evaluations, and/or surveys could be transported between the management company and the user, expert and/or professional using a courier. The survey would preferably include questions seeking both quantitative and qualitative information. For example, the survey could include questions concerning the accuracy of the service and/or advice given, as well as questions concerning whether the experience with the provider was a satisfactory one. Such a survey could be designed using methods well known in the field of surveys. For example, the survey could include alternate forms of questions which seek to obtain the same, or similar, answers. Inconsistent answers could be rejected and/or tagged for follow-up by the service provider for clarification or validation. Preferentially, the database would be updated in a manner that ensured the anonymity of the user.

In further embodiments, functionality could be added for dealing with database “misses.” For example, a user seeking advice from a service provider whose database correlated genomic data and responses to food might, for example, ask about a food which was not processed in the database. This would constitute a database “miss.” As a result, the service provider might process collected genomic data and collected responses to various foods, find correlations between the genomic data and responses to the food which was not in the database, and add data concerning response to the food to the database. In other cases, in response to a database miss an expert may be contacted. For example, if a user's request for disease susceptibility information from a service provider led to a database miss, the service provider might employ the services of a genetic disease expert to answer the user's query and/or update the database. In some embodiments, service providers may employ algorithms which act upon, or take as input, all or part of a user's genomic data. In some embodiments, service providers may use one or more devices to perform the above-described tasks such as employing algorithms, contacting genetic experts, and updating, maintaining, and consulting databases. Such devices may include general purpose computers known in the art, such as PC's and engineering workstations. In some embodiments, these devices would be connected to management device 100, perhaps via the Internet.

Genomic and related services described herein that employ databases may make use of the teachings of pending PCT International Application PCT/US00/7540 “Methods for Obtaining and Using Haplotype Data” (filed Jun. 26th, 2000; WO 01/01218), incorporated herein by reference. This application discloses methods, computer programs and databases to analyze and make use of gene haplotype information. These include methods, programs, and databases to find and measure the frequency of haplotypes in the general population; methods, program, and database to find correlation's between an individuals' haplotypes or genotypes and a clinical outcome; methods, programs, and databases to predict an individual's haplotypes from the individual's genotype for a gene; and methods, programs, and databases to predict an individual's clinical response to a treatment based on the individual's genotype or haplotype. Similarly, such services may employ the teachings of pending PCT International Application PCT/US01/12831 “Method and System for Determining Haplotypes from a Collection of Polymorphisms” (filed Apr. 18, 2001; WO 01/80156), incorporated herein by reference. This application discloses methods, computer programs and databases for identifying the haplotypes that exist in a population and methods, programs and databases for predicting an individual's haplotype for a gene from the individual's genotype for that gene.

As was illustrated in the above example, one example of a service is a genetic test which returns a result explaining a susceptibility to a disease. Another such service is a “custom product” service.

A custom product service produces products based on one's genome. An example of this would be the production of music, jewelry or clothing whose design is derived from an individual's genomic data. For example, one-of-a-kind tee shirts or quilts could be designed by employing an algorithm that created a unique graphic based on a person's genomic data. Alternately, the shirts or quilts could be designed by accessing a database which correlates graphic designs or design components with genomic features such as haplotypes. A further example of a custom product would be a food that was produced so as to be especially appealing to the purchasing individual's genetically-determined sense of taste, as indicated by her genomic data. To achieve this, the service provider might, for example, maintain a database correlating, perhaps statistically, the presence of certain haplotypes or haplotype pairs in ones genome with liking certain flavors or textures. The service provider, upon receiving a food or meal request, would use the user's genomic data to consult the database in order to create a food or meal that the purchaser was likely to enjoy.

A similar example of a custom product would be a food or meal that was produced so as to be particularly appropriate for the purchasing individual's genetically-determined nutritional needs. In this case, the service provider might, for example, maintain a database correlating, perhaps statistically, the presence of certain haplotypes or haplotype pairs in one's genome with certain dietary needs. The service provider, upon receiving a food or meal request, would use the user's genomic data to consult the database in order to create a food or meal that would be a good fit for the purchaser's nutritional needs. In some embodiments, recipes and menus for the food or meal would be provided to the user. Alternately, the food or meal could be prepared for and delivered to the user.

Still another example of a custom product would be a musical composition that was designed so as to be especially appealing to the purchasing individual's genetically-determined sense of what is aurally pleasing, as indicated by her genomic data. To achieve this, the service provider might maintain a database correlating, perhaps statistically, the presence of certain haplotypes or haplotype pairs in one's genome with liking certain musical styles or constructions. The service provider, upon receiving a musical composition request, would consult the database in light of the user's genomic data in order to create a musical composition that the purchaser was likely to enjoy.

In some embodiments, functionality could be added for updating the database and/or algorithm, for example, by using feedback such as feedback evaluating the appeal of the provided product, using methods such as those described above, including surveys. Preferentially, the database would be updated in a manner that ensured the anonymity of the user.

Another service illustrated in the exemplary web page menu is for a user to access current medical information or subscribe to medical information updates. For example, a user may choose to access current or up-to-date medical information such as scientific articles, news articles, lectures, and films about diseases, drugs, nutritional supplements, and the like. Such information could be provided online, by e-mail, by physical delivery or other methods. A user choosing to subscribe to such information might, for example, select to receive each week all scientific articles relating to a specific disease. In some embodiments, users may choose to receive information based on their genomic data and/or additional information. For example, a user might choose to receive each week all scientific articles relating to the genetic diseases for which, according to her genomic data and/or additional information, she is at risk. In such an embodiment, the system could determine which articles would be appropriate for the user by consulting a database in which genomic data and/or additional information was correlated with increased likelihood of certain genetic diseases. In some embodiments, functionality could be added for updating the database, for example, by using feedback such as feedback evaluating the appropriateness of the provided articles, using methods such as those described above, including surveys. Preferentially, the database would be updated in a manner that ensured the anonymity of the user.

Still another service illustrated in the exemplary web page menu is for a user to route her genomic data to a Specified Party. For example, a user might use this feature to route her genomic data and/or additional information to a service provider not listed on any of the web page menus.

Also as seen in the sample web page menu, another service is for the user to participate in a test. One example of this would be a test run by medical researchers (including, but not limited to, a clinical trial), while another would be one run by market researchers. This is another case where the provider might require that additional information be routed along with the genomic data. For example, for a market researcher the additional information might be the food preference of the user. Such a provider's goal may be to statistically correlate food preference with the presence in the genome of certain markers. On the other hand, for a medical researcher, the additional information might be information relating to childhood illness suffered by the individual, the individual's lifestyle activities, or the individual's dietary habits. As is the case with all of the services, this service could conceivably be provided by the management company, a third party, or both. The system may provide for reimbursement of the user in exchange for the information as well as payment of a processing fee to the management company.

Another example of genomic-based services are games in which gameplay is based on and/or affected by a user's genomic makeup. For example, a multi-player game might employ an algorithm by which the player's genomic data would change the gameplay scenario, manipulate on-screen images, produce audible events, give game characters strengths or weaknesses (including illnesses) or otherwise affect the player's capabilities, or determine team assignment. In some embodiments, functionality could be added for updating the algorithm, for example, by using feedback such as feedback evaluating the appeal of the gameplay experience, using methods such as those described above, including surveys. Preferentially, the database would be updated in a manner that ensured the anonymity of the user.

Still another example of a genomic-based service is to provide health and lifestyle information and guidance on various topics based, at least in part, on a person's genomic data.

For example, a person choosing “health and lifestyle advice” from the main menu might be shown the below sub-menu:
1) What diseases do I have a genetic propensity for, and what preventative steps can I take now?
2) What is a recommended diet for me?
3) What is a recommended exercise program for me?
4) What sports would I be best at?
5) What genetic risks would my children face based on my genomic data and/or family history?
6) (Two users only) What enetic risks would our children face based on our genomic data and/or family histories?

To execute such selections, a user's genomic data, along with any necessary additional information such as the user's weight, age, and family history, could be considered by using a database which correlates genomic data, and in some cases additional information, with lifestyle advice. Such lifestyle advice might include advice on taking preventative steps against the onset of a genetic illness or a condition to which an individual is genetically predisposed, diet recommendations, exercise recommendations, or the like. For example, a consultation of the database may yield the advice that the user should stop smoking because she is prone to arteriosclerosis.

In alternate embodiments, the database would correlate genomic elements, and in some cases “additional information,” with information concerning diseases, lifestyle outcomes, and the like instead of advice. In such an embodiment, the system would need to take additional steps to provide advice related to this information. In one embodiment, a second database could be used to yield the actual advice. For example, a consultation or the first database may show that the user is prone to arteriosclerosis. This information may be used to consult a second database, which would yield the advice that the user should stop smoking.

For example, a user might ask about what sports she would be best at. A consultation of the database in light of her genomic data might yield the answer that she had a higher than average percentage of white muscle tissue and thus would be better at sports that require sprinting than endurance. The system might also recommend appropriate exercises if she were more interested in improving her performance in other types of sports. Another user, asking “What diseases do I have a genetic propensity for, and what preventative steps can I take now?” might learn that he was particularly susceptible to the effects of cigarette smoking and should quit immediately. In some embodiments, the system could provide estimated risks, which could vary as further information was obtained and integrated into the database.

In certain embodiments, two users could jointly ask a question of the system and have their genomic data jointly compared. For example, a couple planning on having children could have their genomic data jointly compared so that they could determine what genetic risks their planned children would face.

This service would provide more functionality than simple genomic testing, because results would preferably not just be a simple “yes” or “no” but would include lifestyle advice. In some embodiments, a counselor would be on call (by phone, on-line, etc.) to answer any questions the user had-about the results provided by the database. In preferred embodiments, the results provided by the database would be “dynamic”. This is to say that the results provided would change as more information were obtained from various sources (such as users) and analyzed. A related service provides users with trivial information concerning their genomes. For example, a user who selected from the menu system the question “what's genetically unique about me?” might learn that she lacked a psoas minor, one of the five muscles of the human body which are most frequently absent.

In some embodiments, functionality could be added for updating the database, for example, by using feedback received in connection with previously provided genomic services such as feedback evaluating the accuracy and/or utility of the provided health and/or lifestyle information and/or guidance, using methods similar to those described above, including surveys. For example, a survey could include questions concerning the accuracy of health and/or lifestyle information and/or guidance given, as well as questions concerning whether the provided information lead to a perceived lifestyle improvement and answers to these questions could be used to update the database. Preferentially, the database would be updated in a manner that ensured the anonymity of the user.

Still another service is a food, drug and nutritional supplement guidance service. In one embodiment, a user, preferably working with her physician, pharmacist, or nutritional supplement expert selects “Food, Drug and Nutritional Supplement Guidance” from the menu system of an I/O terminal. Such an I/O terminal, perhaps connected to management device 100 via the Internet, could be located in a physician's office, health food store, or pharmacy, so that the genetically-guided prescription or usage suggestion of drugs and nutritional supplements could be unobtrusively incorporated into clinical or pharmaceutical practice or store operation.

The user's genomic data, along with necessary additional information such as the proposed prescription or usage suggestion and perhaps demographic information such as the user's weight, age, and family history, is then considered in light of the content of a database. The database preferably correlates genomic data (such as haplotypes, haplotype pairs, SNPs, methylation patterns, and the like), and perhaps certain additional information, with responses to specific over-the counter drugs, prescription-only drugs, nutritional supplements, and similar products. In preferred embodiments, the database can be updated as new information is obtained. Using the result of the database consultation, the system creates a report with product and dosage advice, adverse reaction warnings, and the like.

In some embodiments, the routing/intelligence unit would, as above, make the report available only to the user. It would be the user's responsibility to pass the report to the physician, pharmacist or nutritional supplement expert.

In other embodiments, the user's doctor or pharmacist receives the report, but has no access to any genomic data of the patient. Preferably, the physician or pharmacist would receive the report after accessing the system using the pharmacy or medical office I/O terminal and entering a password. In still other embodiments, the report would be delivered to the physician or pharmacist, but in such a manner that it could not be read by the physician or pharmacist without the presence or consent of the patient. For example, the user might need to enter a password on the medical office I/O terminal in order to allow the physician or pharmacist to view the report. In another embodiment, the user's consent or presence would be determined by taking the user's fingerprint, voiceprint or retinal scan. Alternatively, the patient might choose to entrust the physician or pharmacist with the password. In certain embodiments, there may be different passwords for access to different information or data. For example, the system may create or allow the use of a password which offered a physician access to results of a test that she ordered for a user, but to no other information regarding that user. In another embodiment, the physician or pharmacist would be able to access the report without the user's permission, e.g, if the report was deemed critically necessary for providing appropriate medical treatment to an unconscious or mentally incapacitated user or to a relative of a deceased user.

In a preferred embodiment, when it is time for a product refill, the database is re-consulted and a new report is created so that the prescription can be changed to reflect any updated genomic-based prescription advice.

In some embodiments, the user, doctor, pharmacist, or other professional could forward the patient's actual drug reaction to the service provider so that the database could be updated to take into account the reported drug reaction when giving future advice. The service provider could use this information to refine statistical correlations of drug responses with genomic data and/or other data. Preferentially, the database would be updated in a manner that ensured the anonymity of the patient. In certain embodiments routing/intelligence device 101 could forward the patient's reaction from the professional to the service provider. Such behavior could be achieved, for example by having the professional enter the reaction into an I/O terminal connected to management device 100 via the Internet. In some embodiments, the professional would report the drug reaction by answering questions on a survey and returning it to the service provider. In such embodiments routing/intelligence device 101 could route a survey from the service provider to the professional's I/O terminal and, after the professional completed the survey using the I/O terminal, route the completed survey to the service provider. In alternate embodiments, results and/or surveys could be transported between the service provider and the professional using a courier.

The survey would preferably include questions seeking both quantitative and qualitative information. For example, the survey could include questions concerning actual physical test results or responses, as well as questions concerning whether the response was sufficient for the physician to decide to maintain the patient on the drug. Such a survey could be designed using methods well known in the field of surveys. For example, the survey could include alternate forms of questions which seek to obtain the same, or similar, answers. Inconsistent answers could be rejected and/or tagged for follow-up by the service provider for clarification or validation. Further, the report could be updated at the time the product was refilled. This update could be based on additional information which was added to the database since it was last consulted, such as the user's response to the prescribed product and dose, the user's response to other product, as well as information from other users or other sources. Preferentially, the database would be updated in a manner that ensured the anonymity of the user.

In additional embodiments, the food, drug and/or nutritional supplement guidance report may not only give information for a drug or nutritional supplement chosen by a physician or pharmacist, but may also suggest that a different product be used. For example, a physician may ask for a food, drug and nutritional supplement guidance report for drug A for a particular patient. The consultation of the database would yield not only potential lack of efficacy or adverse reactions, but also the advice that Drug B would be a better choice based on one or more of the patient's genetic profile, lifestyle information, and other additional information.

In further embodiments, a physician, pharmacist or other professional would not have to submit a proposed prescription. Instead, the professional would submit, or request the retrieval from storage of, any required additional information such as diagnostic values, symptoms, and/or a diagnosis of the patient's condition. Based on the genomic data and any additional information, a profile would be created which would suggest one or more drugs, preferably noting for each one a suggested dose and/or efficacy rating. In a preferred embodiment, probable side effects would also be listed.

For example, a physician may submit, or request the retrieval from storage of, a patient's blood lipid level, age, gender or other relevant information relating to a patient's cardiovascular disease. The report created based on this information and the patient's genomic data might contain the prediction that the patient had a 90% chance of responding to a first lipid-modulating drug, a 80% chance of responding to a second lipid-modulating drug, and a 20% chance of responding to a third lipid-modulating drug, along with a dosage suggestion for each drug. The physician would then be able to choose which of the three drugs she wished to use for the patient. For example, the physician may choose the second drug if it is in a hospital's formulary, or the patient's HMO formulary, but the first drug is not.

In one embodiment, a physician may choose to prescribe to a patient a particular drug or dosage regimen for such drug even though the report predicts that the patient will exhibit an adverse response to that drug or dosage regimen. In this case, the physician would monitor the patient for the adverse response while on the drug, and afterwards, if medically appropriate. Because an adverse response to the drug may affect the patient's compliance with the prescribed dosage regimen, the physician may also choose to more closely monitor how and when the patient is consuming the drug.

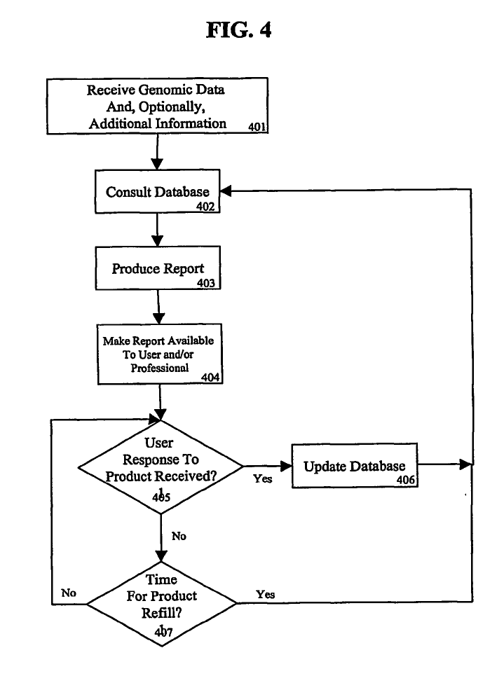

FIG. 4 is a flow chart showing one exemplary embodiment of the operation of the above-described food, drug, and/or nutritional supplement guidance service. These steps may be performed, for example, by a general purpose computer. In step 401 an individual's genomic data, and optionally additional information, is received. In step 402, the database is consulted. Next a report is produced (step 403) and made available to the user and/or a professional assisting the user (step 404). In step 405, it is determined if the user's (and/or other user(s)') response to the product has been received. If the answer is “yes,” flow proceeds to step 406 where the database is updated using the user's (and/or other user(s)') response and then returns to step 402, where the database is consulted and an updated report is produced based on data incorporating the user's (and/or other user(s)') response. If the answer in step 405 is “no,” flow proceeds to step 407 where it is determined if it is time for a product refill. If the answer is “yes,” flow proceeds to step 402. If the answer is “no,” flow proceeds to step 405.

In a second embodiment, the food, drug, and nutritional supplement guidance service would operate in a manner similar to the first embodiment, the main difference being that it would provide advice concerning the use of foods instead of drugs and nutritional supplements. In one instance of this embodiment a user, preferably working with a nutritionist or healthcare professional, would submit a suggested food, menu, or diet, along with any necessary additional information, in the manner discussed in the first embodiment. Alternately, this embodiment is compatible with a food market or restaurant environment wherein a clerk, server, or the like would enter a proposed meal or food purchase along with any necessary additional information into an I/O workstation located on the premises. The submitted genomic and additional information would be considered in light of a database which correlated genomic data with dietary restrictions and dietary guidance, and an advisory report would be created.

In a third embodiment, the food, drug and nutritional supplement guidance service would operate in a manner similar to the first two embodiments, but the I/O workstation used to enter data would be in the form of a computerized cash register or similar device located in a food market, health food store, pharmacy, restaurant or the like. Alternately, the I/O workstation could be a web browser used to make online purchases. This embodiment could provide genetically-guided point of sale advice concerning the purchase of food, drugs, nutritional supplements and other products.

For example, a mother whose child had PKU (pkenylketonuria) might attempt to purchase for her child a soft drink bottle at a store whose cash registers functioned as I/O workstations. The child's genomic data, along with perhaps additional information, would be considered in light of a database that correlated genomic data and perhaps additional information with responses to foods and other products. As a result of the database consultation the system might advise the mother that the purchase was not advised because the soft drink contained phenylalanine, a substance which would be harmful to the child due to her genetic makeup.

This point of sale embodiment could also advise users against the purchases of foods they were allergic to or that were problematic for reasons such as inborn errors of metabolism, or advise against the purchase of over-the-counter drugs or nutritional supplements which were not ideally genetically compatible or were genetically problematic. In some embodiments, the system could suggest alternate foods, drugs, or other products that were more genetically compatible or less genetically harmful than the products that the user was attempting to purchase.

Still another function of the system is to broker financial transactions related to management of genomic data. In order to implement this feature, the routing/intelligence device 101 could execute one or more of the below-described billing schemes. Billing records could be held on the storage unit, while monetary transfer could be achieved using electronic finds transfer (EFT) and credit card billing techniques well known in the art.

In one aspect, individuals storing their genomic data in the system may be charged a fee by the management company for various actions. For example, individuals may be charged a fee for collection and/or processing of their biological sample so as to yield genomic data. Individuals may further be charged a fee for initially establishing a management account and/or a fee for maintaining the account. The latter fee, for example, might take the form of a monthly or annual fee. Individuals may also be charged for further processing of their DNA or initial sample, or for processing of an additional sample, to yield additional genomic data. For example, a fee may be charged to a user who had initially paid to have only five genes or haplotypes recorded as her genomic data, but later chose to have additional genes or haplotypes recorded. Similarly, users may be charged for adding, deleting, or otherwise revising non-genomic data. In embodiments of the invention which use data cards, individuals may be charged an initial issue fee for a data card, and another fee if the card is lost or damaged and needs to be replaced.

Fees may be charged for the routing of genomic data and/or other information to service providers, both third party providers and those run by the management company. For example, in some embodiments an individual may be charged a fee when the system routes her genomic data to a service provider. If the service provider is a third party, the third party, instead of the individual, may be charged the fee. In still other embodiments, both the third party provider and the individual are charged. In other embodiments, the management company may pay a fee or credit the account of a user for use of her genomic or other information.

In some embodiments, users may opt to pay a one-time fee rather than being charged for various actions and/or for having their genomic data and/or other information routed to service providers. For example, a one-time fee might entitle a user to have her sample collected and processed, her management account established and maintained for life, and her genomic data and/or other information routed to service providers without additional cost. In some embodiments, there may be limitations to what one is entitled to after paying a one-time fee. For example, the payment of the one-time fee might entitle one to a certain number of routings a year with additional routings being available for an extra cost.

Further, fees may be charged for the services themselves. For example, for services provided by third parties, the system may act as an intermediary and collect money from the individual on behalf of the third party. In preferred embodiments, the third party would be charged a fee for this billing and collection service. For “home services” provided by the management company, the management company may directly bill the individual. For example, home services which provide lifestyle advice might charge a fee for each piece of advice given. Games may charge a fee per play, or per unit of time the game is played. As a further example, fees may be charged for system functions related to food, drug and nutritional supplement guidance profiles. For example, a fee may be charged for each profile created. This fee may be charged to the individual, the medical or other professional, or both.

In some embodiments, drug companies may be charged fees when a drug is prescribed on the advice of a food, drug and nutritional supplement guidance profile. For example, a drug company may be charged a “finder's fee” if a drug is chosen by a doctor on the advice of a food, drug and nutritional supplement guidance profile. For example, a physician may ask for a food, drug and nutritional supplement guidance profile for drug A, produced by company X, for a particular patient, and be advised that Drug B, produced by company Y, would be a better fit based on the patient's genetic profile. If the company X were different from company Y, company Y may be charged a “finder's fee” if there was a business agreement between company Y and the management company.

In other embodiments, a healthcare payer (e.g., a health insurance company or HMO) may only reimburse a healthcare provider, or its insured patient, for service fees or drug costs that are incurred in connection with the insured's medical treatment if the healthcare provider prescribes or dispenses a drug or therapy that is predicted to provide the patient with the most medically- and/or cost-effective care based on the patient's genomic data. Thus, for example, if the patient has cardiovascular disease and is in need of a statin and is predicted to have less severe side effects or a greater reduction in LDL-cholesterol to statin A than statin B, an insurance company or HMO would only reimburse the healthcare provider for the patient's care in regard to cardiovascular disease if the healthcare provider prescribes or dispenses statin A to the individual. In another embodiment, the healthcare payer may not require that the healthcare provider prescribe the best drug for the individual (based on the individual's DNA) but one of the better drugs. For example, if the individual is in need of a reduction in cholesterol, and drugs A, B, C, and D are each predicted to cause a 20%, 24%, 32% and 5% decrease, respectively, in cholesterol in the individual, an insurance company or HMO may reimburse the health care provider (or the patient) if the individual is prescribed drug A, B or C, but not D.

In some embodiments, the level of medical- and cost-effectiveness of certain therapies that qualifies for reimbursement may be specified in the patient's contract with the healthcare payer. In other embodiments, whether the level of efficacy and/or safety predicted for a proposed therapy qualifies for reimbursement may be determined on a case by case basis by the healthcare payer in consultation with medical experts and/or with the insured's healthcare provider. In another embodiment, the insurance company or HMO may only reimburse the healthcare provider (or the patient) if the patient is prescribed or receives a drug that the management company recommends for the patient based on the patient's genomic data and preferably other patient information relevant to providing therapeutic guidance. The invention contemplates that this recommendation may be transmitted by the management company directly to the healthcare payer, who in some embodiments, may pay the management company a fee for such transmittal.

In yet another embodiment, a drug may be indicated for individuals with a certain haplotype profile, and the insurance company would only reimburse the health care provider (or the insured individual) for prescription or purchase of the drug if the insured individual has that haplotype profile. The presence or absence of the haplotype profile in a patient may be ascertained by using any of the genomic services described herein or by the performance of a genetic test that is designed specifically for determining whether a patient belongs to the genetically-defined population that is part of the approved indication for the drug.

In all the above embodiments, the healthcare provider may be a physician, group of physician's, hospital, clinic, nurse or physician's assistant. In other embodiments, the healthcare provider may be a pharmacy, pharmacist, or other entity that dispenses medications to individuals.

The system also includes methods of facilitating the earning of money by users. In such embodiments, the system may, in response to an individual's request to earn money by participating in a study, seek out or receive requests from one or more third parties interested in using some or all of an individual's genomic data and/or other information for purposes such as research. For example, the intelligence module might maintain a list of pharmaceutical companies, academic institutions, or contract research organizations and periodically e-mail the research directors or other appropriate personnel of these institutions to learn what sort of research participants are currently being sought. Alternately, the management company might advertise itself in medical and scientific journal as a “clearing house” for research participants. In such a case, research groups seeking participants would contact the management company or intelligence module that is requesting participants with certain characteristics.

The system bargains with the third parties to decide upon the fee the third party will pay for the use of the genomic data and/or other information of a particular user. This is especially effective in cases where more than one third party is interested in using the data and/or other information, but only one will be awarded use. The brokering might include not only negotiation of price to be paid, but also amount of genomic data and/or other information used. For example, a third party might initially request information about three of an individual's haplotypes, but as result of the negotiation it might be bargained that only two would be used.

In some embodiments, once the system had come up with a highest price for the use of an individual's genomic data or other information, the system would inform the individual of how much money she would get, what specific data or other information would be used, and the purpose of the use. The system would seek the user's agreement, and would not execute the transaction with the third party unless agreement was received.

In alternate embodiments, the system notifies an individual of a research project seeking participants, informs the individual of the nature of a research project and of the data being sought, and asks the individual if she is interested in having a place in the project negotiated for her, and if so under what conditions. For example, the user might state the condition that she was only interested in participating if she would receive at least $100, or that she was only willing to allow 5 of the 10 requested haplotypes to be used. The system would take such conditions into account during the bargaining process. In some embodiments, users could set default values concerning the conditions under which they would be interested in entering a research project. For example, an individual might set as her default profile that she only wanted to participate in medically-related projects related to a particular disease, such as breast cancer, or projects in which she would receive at least $75.

Preferably, as above, once the system had come up with a best-price for the use of an individual's genomic data and/or other information, the system would seek the user's agreement, and would not proceed unless agreement was received. Alternately, however, a user may agree ahead of time to participate in the project so long as her minimum conditions were met. It is understood that, in some cases, higher prices could be paid to the participating users when there is a high level of participation by other users, or approval to use more genomic data or other information that initially estimated. For example, it could be provided that the fee paid to an individual will increase as the amount of data she provided increases or the level of participation by other users increases.

In preferred embodiments, the system would charge for its negotiation services. In one embodiment, the system would take a percentage of the money agreed to be paid, while in other embodiments the system would take a flat fee equal to a certain amount of money. Such monies could be collected from the individual, the third party, or both. In some embodiments, the individual or third party might be allowed to choose between the two charging models, preferably before the result of the auction was announced to the user. In some embodiments, the management company might accept access to a provider's services in lieu of money owed to it by that provider.

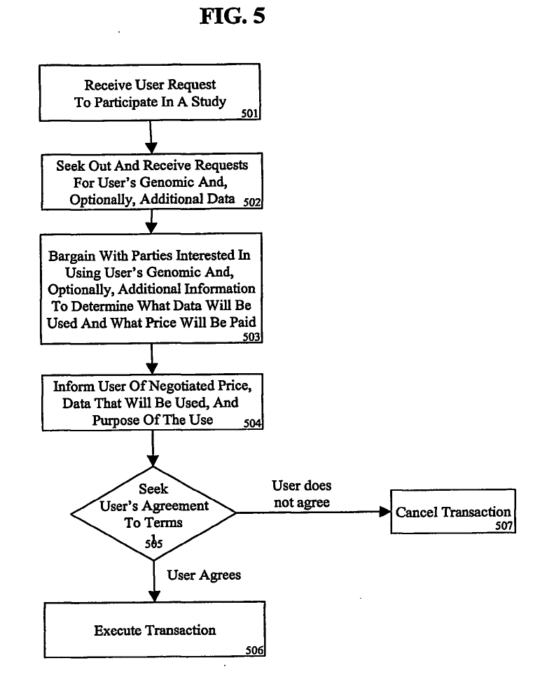

FIG. 5 is a flow chart showing one exemplary embodiment of the above-described procedure. These steps may be performed, for example, by routing/intelligence device 101. In step 501, a user's request to participate in a study is received. In step 502, requests are sought out and received for the user's genomic and, optionally, additional information. In step 503, the parties interested in using the user's genomic data and, optionally, additional information are bargained with in order to determine what data will be used and what price will be paid. In step 504, the user is informed of the negotiated price, the data that will be used, and the purpose of the use. In step 505, the user's agreement to the proposed terms is sought. If the user does not agree, flow proceeds to step 507 where the transaction is canceled. If the user does agree, flow proceeds to step 506 where the transaction is executed.

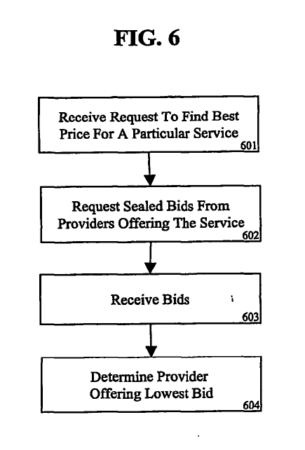

As noted above, in some embodiments the system works to find the best price for a particular service when that service is offered by more than one provider. In one embodiment, the intelligence module 101 requests “sealed bids” from each of the providers offering the service. The intelligence module then selects the lowest bid, and forwards this information to the user. Alternately, the system could request that the user name the price she wanted to pay. The system would then forward this information to the providers offering the service, and see if any were willing to provide the service for the noted price. Other auctioning methods of securing a fair market price will be apparent to those skilled in the art. In certain embodiments the system might consider the quality of the providers when finding the best price for a particular service, perhaps by considering quality rankings or seals of approval. In some cases, a user could specify quality requirements when requesting that the system find a best price for a service. For example, a user could specify that she wants the best price among providers with a quality rating of three or more stars. Additionally, the management company could set quality requirements that could be applied to all user requests to find the best price for a service. For example, the management company might decide that the system would, when finding a best price for a customer, only consider providers who had been granted seals of approval. In further embodiments, the management company may charge the user for the service of having been secured a fair market price, charge the provider for the service of having found them a customer, or charge both parties. FIG. 6 is a flow chart showing one exemplary embodiment of this procedure. These steps may be performed, for example, by routing/intelligence device 101. In step 601, a request is received to find a best price for a particular service. In step 602, sealed bids are requested from providers offering the service, and in step 603 the bids are received. In step 604, it is determined which provider is offering the lowest bid.

As noted above, some embodiments of the data card allow it to be used to make purchases. Such functionality can be easily implemented by the system because it can perform conventional EFT and credit card billing functions in performing the abovementioned financial transactions.

In the embodiments of the data card that include financial transaction capability, users might be able to earn money points if they allowed the management company to anonymously record information concerning their purchases. Such information could be recorded, for example, each time a user makes a purchase using her data card. The goal in doing so would be to create databases correlating genomic data such as haplotypes and purchasing or consumption habits. In some embodiments, product and/or purchasing suggestions could be made based on these correlations. These suggestions could be offered to the users. The management company could construct the database in such a way that no personally-identifying information would be included. In this way the user's anonymity would be maintained. In some embodiments, the management company would sell its suggestions and/or statistical correlations, or the use thereof, to third parties. In some embodiments, routing/intelligence device 101 may be configured to perform these functions.

In some embodiments, functionality could be added for updating the database, for example, by using feedback such as feedback evaluating the appeal of a suggested product or the accuracy of the provided statistical correlations, using methods described above, including surveys. For example, the survey could include questions concerning the accuracy of the correlations, as well as questions concerning whether the suggested product was appealing. Preferentially, the database would be updated in a manner that ensured the anonymity of the user.

Other embodiments might provide this functionality without the use of a data card with financial transaction capability. For example, in some embodiments the purchasing information could be recorded at a cash register and forwarded to the management company physically or electronically. In other embodiments, users may submit their own purchasing information, perhaps by filling out a questionnaire or by submitting copies of store purchase receipts. Such submission could also be done electronically or physically.

In other embodiments, the user could give permission for her identity and genomic data relating to her purchasing habits to be disclosed to third parties.

As alluded to above, a further function implemented by the system is to route an individual's genomic data, and any appropriate additional information, to a provider of a requested service, such as a third party provider or the management company.

As explained previously, a guiding principle behind this function is that an individual's genomic data may only be used by another party with the individual's permission. Accordingly, in preferred embodiments, care is taken that these parties never hold or posses a patient's genomic data, that they are not allowed to download the data, and that they are only allowed to use it for the purposes agreed upon and for the duration of time agreed upon. Further, it is preferred that a party does not know the identity of the individual to whom it is providing a particular service.

In certain embodiments, when the management company owns or runs service providers such as for providing the service of correlating an individual's genomic information with drug response, these service providers will face the same restrictions as third party service providers. For example, in preferred embodiments, while certain personnel of the management company will have access to user identities, steps will be taken so the personnel that work in a service provider division of the management company, in other words personnel responsible for performing services, will not know the identities of individuals to whom they provide services. Further, while the management company may store genomic data, it is preferred that service provider divisions of the company will not be allowed to download and keep the data. Thus, in certain embodiments, the genomic data shall be secured by appropriate internal safeguards so that it is only used for authorized uses by appropriate personnel.

In order to meet this goal, special techniques are used for the transmission of genomic and/or other data. In a first embodiment, service providers access the genomic data via a transient storage area on storage device 102. In a second embodiment, the service provider downloads a “self-destructing” data package containing the genomic data in an encrypted format. In a third embodiment, the service provider physically receives a “self-destructing” data card containing the genomic data. In a fourth embodiment, the service provider reads the data directly from the data card during the period of time which the card is in the reader. Each of these embodiments will now be discussed in detail. Other embodiments are apparent to those skilled in the art.

In an example of the first embodiment, once permission has been secured the genomic data and any additional information is copied to a “transient storage area” to which the service provider is granted access. In a preferred embodiment, a temporary identification number corresponding to the user and a description of the service requested is also copied to the transient storage area. By use of a temporary identification number, the service provider does not know the identity of the individual for whom the service is being performed.

In embodiments where the genomic or additional information is stored on a data card, the user places her card in an I/O terminal with card reader 105. The data is copied from the card to the transient storage area.

In embodiments where the genomic or additional information is stored on storage device 102, this copying may be actual or virtual. In the actual case, the data is copied to the transient storage area and the service provider is given access to this transient area In the virtual case, the data is not moved from or copied from the original storage area, but instead the service provider is given expiring access to the original storage area.

In preferred embodiments, the service provider could only access the data through an active connection, and would be prevented from downloading the data. One method for achieving this would be set restrictions on the file so that it could be read but not copied or written to. Such file restrictions are used in most modern computer operating systems, and thus the methods for implementing them are well known in the art. Further, the data could be encoded in such a way that it would check where it was stored before allowing access to itself. Thus, if it were somehow downloaded to a storage location other than the one it was intended to be stored on, it would not allow itself to be accessed. Techniques such as this are well known in the art, as they are used to ensure, for example, that a program licensed to run on a specific computer only runs on that computer.

The temporary identification number functionality may be implemented in a manner similar to the disclosed method for ensuring anonymous processing of the initial genetic sample. Thus the management company may generate a semi-random temporary identification number and associate this number in a lookup table with an individual's identity. Alternately, a cryptographic algorithm may be used. As described above, the service provider would have access to the temporary identification number, the genomic data, any additional information, and description of the requested service. The service provider would return the results of the service, along with the corresponding temporary identification number, to the management company. The management company, upon receipt of the information, would ascertain from the returned temporary identification number which individual's service results had been received. The results would then be made available to the individual, and the temporary identification number would be de-correlated from the individual so that the number could be reused.

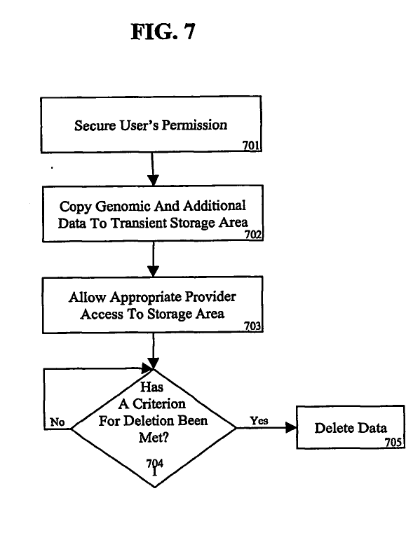

The phrase “transient storage area” emphasizes the fact the system will delete, or otherwise render unreadable, the data in this storage area under a number of circumstances. For example, the data might be deleted after a certain date has been reached or a certain period of time has elapsed. The data might also be deleted if the service provider attempts to copy it. Further, in cases where the genomic data is stored on a data card, the data might be deleted upon removal of the card from the card reader. The data might also be deleted if the service provider attempts to handle the data in a manner other than the one agreed upon. For example, the data might be deleted if the service provider attempted to perform tests on it other than those agreed upon. In this way, the individual could feel assured that his genomic data would only be used for the purposes she agreed to and the service provider would be prevented from having permanent possession of the user's data. FIG. 7 is a flow chart showing one exemplary embodiment of the above-described procedure. These steps may be performed, for example, by routing/intelligence device 101. In step 701 the user's permission is secured. In step 702, the user's genomic data and additional information is copied to the transient storage area. In step 703, the appropriate provider is allowed access to the storage area. In step 704 it is determined if a criterion for deletion has been met. If the answer is “yes,” flow proceeds to step 705 where the data is deleted. If the answer is “no,” flow proceeds to step 704.

In the second embodiment, the system would copy the genomic and additional information in the manner disclosed for the first embodiment. However, instead of the data being copied to a transient storage area, a “self-destructing” data package containing the data is created by the system. In preferred embodiments, the identification number and the description of the service requested are also placed in this data package. The system allows the service provider to download this package. The phrase “self-destructing” refers to the fact that the package is capable of deleting itself, or otherwise rendering the data that it carries unreadable. There are a number of circumstances under which the data would self-destruct. These circumstances may include the sample circumstances that led to deletion of data from the transient storage area in the first embodiment. For example, the package might be set with an expiring-self-destruct. In such a case, the package would destroy its data after a certain date had been reached or a certain period of time had elapsed. The data might also be set to self-destruct if the service provider attempted to copy it. Further, in cases where the genomic data is stored on a data card, the data might be set to self-destruct upon removal of the card from the card reader. In these ways, the service provider would be prevented from having permanent possession of the user's data. Further, the package might be set to self-destruct if the service provider attempted to handle the data in a manner other than the one agreed upon. For example, the data might self destruct if the provider attempted to perform tests on it other than those agreed upon. In this way, the individual could feel assured that his genomic data would only be used for the purposes she agreed to.

To deal with the eventuality of the package being intercepted in transport, additional self-destruct events could be added. For example, the package could have its data stored in an encrypted format, and be programmed to “self-destruct” if an incorrect key were applied to it. Further, the package could be programmed with a “self-destructing countdown timer”. In such an embodiment, when the card was shipped a self-destruction countdown timer would be set, perhaps for 12 hours. When the service provider claimed receipt of the package, the management company would give the service provider a code with which to “defuse” the self-destruction countdown. Hence, if the package were intercepted in transport, the interceptor would not know the code with which to defuse the countdown, and thus the data on the card would self-destruct after the allotted time elapsed. Such a self-destruction countdown timer should not be confused with the above described expiring-self-destruct feature. An important difference between the two is that the countdown timer can be “defused,” while the expiring-self-destruct cannot.

The third embodiment is like the second, but the data package is not made available to the service provider for downloading. Instead, it is placed on a data card that is physically delivered to the service provider.

Such a “self-destructing data card” would preferably be a smart card or some other card with on-board computing abilities. The on-board computational device would be programmed with a series of events that should result in “self-destruction” of the data, as well as with a self-destruct routine. These events would include, among others, those described in connection with the above-described self-destructing data package. The computational device would watch for these events, and when one occurred the processor would execute a routine which would delete the card's data contents. In preferred embodiments, the card would also have the features of the above-described permanent data card. For example, the card would preferably have its data stored in an encrypted format, with the card's on-board processor handing the decryption process.

Thus, in practice, the genomic data, and any additional information, would be loaded onto the self-destructing data card. The self-destructing data card would be physically delivered, preferably via a secure carrier or messenger, to the service provider. Preferably, the data would be stored in an encrypted format for which the service provider would be given a “key”. In this way if the card were intercepted in transport, or someone took improper possession of the card, the contents of the card would be inaccessible.

In the fourth embodiment, the service provider reads the genomic data, and perhaps additional information, directly from a data card. Thus, the provider only has access to this data during the period of time for which the card is in the card reader. Once the card was removed from the reader, access would no longer be possible.

In one scenario, the card reader would be located at the third party's physical location, and the individual would go there to insert his card. In another scenario, the individual would insert the card at a reader distant from the third party, such as a reader-equipped I/O terminal 105, and the service provider would read the data from the card via a secure and preferably encrypted network connection. Preferably, the card reader would capture or otherwise lock the card into place in a manner that it could only be removed from the reader by the owner of the card. In this way the individual could go to a card reader location, insert her card, and retrieve it at a later time.

In one embodiment, the identification number corresponding to the user and a description of the service requested could be delivered to the provider using one of the first three embodiments, while the genomic data itself would be made available using the method of the fourth embodiment. If the provider required additional information which was not on the data card, the provider might receive this data by having the user enter it on an I/O terminal 105. Alternately, the additional information could be delivered to the provider using one of the first three embodiments.

As in the above embodiments, “self-destruct” procedures could be set up to protect the data. For example, the additional information could be sent as a self-destructing data card, and the personal data card would destroy its data if the service provider executed one of the above-described self-destruct events.

Alternately, instead of the personal data card destroying its data, it could instead leave its data intact but cut off the provider's access to it. For example, if the third party attempted to access the data more times than was agreed upon, the provider's access to the card would be cut off, but the card would remain undamaged so as to not inconvenience the owner. In other embodiments, the card would shut off not the provider's access to the card, but all read access to the card. In such embodiments the user would have to reactivate the card to make it functional again, perhaps by inserting it into an I/O terminal with card reader and entering a secret reset code.

In these embodiments, the data is preferably encrypted such that the service provider needs a key to access the data In some embodiments, each service provider is periodically provided a unique “period key” which will be used to decode all data that the provider is to access during that period. For example, the provider may be given a key each month which is to be used to decode all data during that month. In some embodiments the period key would be transmitted via a secure, encrypted transmission. For example, a security officer at the service provider might have a master key that can be used to decrypt the period keys that are provided. In other embodiments, the period key could be delivered physically by bonded messenger.

In some embodiments, the provider may be given a multitude of keys at once. The multitude of keys could be stored in a lookup-table which associates keys with code words. In such an embodiment, the service provider might receive from the management company a daily e-mail or daily physical letter via bonded messenger which contains the code word of the day. For example, the service provider might be informed that “today is an AZSDEFE” day. The service provider would feed “AZSDEFE” into the lookup table in order to receive the day's key.

In still other embodiments, the keys would not be sent to the service providers at all. Instead, each provider could be given a algorithm for creating the keys. The management company could use corresponding algorithms to encode data meant to be read by each provider. For further security, the key-generating algorithm could be a “black box” in the eyes of the service providers, which is to say they would not know how the algorithm worked. These methods provide only examples, and other methods known to those versed in the art for encryption and the providing of keys may be used as well.

In yet another embodiment, the invention concerns a method of marketing a product in a geographic region of interest, comprising obtaining information relating to at least one correlation between users' positive response to the product and at least one haplotype profile, determining the frequency of the haplotype profile in the population living in the geographic region, and making a marketing decision for the geographic region based on the determined frequency of the haplotype profile. As used herein, the term “marketing” means any activity associated with advertising, offering to sell and selling goods or services. The product may be any good or service for which there is a perceived need or demand in a particular geographic region. Preferably, the good or service is medically related, and more preferably the good or service is a drug or biologic, either of which may be previously approved by an appropriate regulatory agency, may be the subject of a pending application for regulatory approval or may be marketed without regulatory approval.

The geographic region of interest may be defined in any one of a number of ways, e.g., by the official or unofficial boundaries of a town, city or section thereof, county, state, multi-state region (e.g., in the United States, the Northeastern, Midwestern, Southern or Western region) country or continent. In one embodiment, the geographic region of interest may be a territory serviced by a healthcare provider such as an individual pharmacy or a pharmaceutical chain. In other embodiments, the geographic region of interest may be a territory serviced by a healthcare payer.

The response to the product includes any type of response exhibited by the user or consumer of the product that indicates the product will at least meet the perceived need or demand for such a product in the geographic region, and preferably indicates this need or demand will be met in a way that is superior to the performance of other products marketed in that geographic region for the same need or demand. In preferred embodiments, the product is a drug or biologic and the response to such a product is the therapeutic profile exhibited by the population present in the geographic region of interest or by a suitable reference population therefor.

Information relating to the haplotype profile correlation may already exist at the time this marketing method is being performed; such preexisting information might be obtained from a provider of genomic services such as the management company described herein. Alternately, obtaining such correlation information requires performing a new study that is designed to identify any correlations between genetic variation and product response that may exist in the population living in the geographic region. The entity seeking to market the product could conduct this study by itself or could contract the performance of this study with another party, e.g., the management company described herein.

The frequency of the correlated haplotype profile(s) in the population in the targeted geographic region may be determined by consulting preexisting genomic data for that population, or a reference population therefor, or by independently testing individuals for the presence or absence of the haplotype profile. The genetic testing may be performed for either most or all individuals of the population of interest to directly determine the frequency of the haplotype profile. Alternately, the haplotype profile frequency in the population of interest may be indirectly determined, or estimated, by the frequency of the haplotype profile that is directly determined for a suitable reference population. As above, the seeking to market the product may determine the frequency of the haplotype profile in the population of interest or may contract with another party, e.g., the management company described herein, to determine this frequency information.

The marketing decision is based on the determined frequency of the haplotype profile in the population living in the geographic region of interest and may include a decision to market the product to the geographic region if the frequency of the haplotype profile correlated with a positive response to the product indicates that the product will achieve a sufficient level of market penetration in the targeted geographic region to meet the business goals and/or profit objectives of the entity seeking to market the product in that region. Alternately, if the frequency of the haplotype profile indicates the product will produce low sales in the geographic region of interest, the marketing decision may be to not proceed with marketing the product in that geographic region.

In yet another embodiment, the invention provides a method for developing a new product to satisfy a particular unmet demand or need of a population, comprising identifying a haplotype profile that is correlated with the unmet demand or need in the population, determining a functional cause for the correlation between the haplotype profile and the unmet need or demand, and developing a new product designed to avoid the functional cause. Examples of unmet demands or needs to which this invention may be applied include but are not limited to weight management, addictions to harmful substances such as nicotine, alcohol and other drugs, and diseases that are not being adequately treated in the population of interest by existing drugs or therapies.

To identify a haplotype profile that is correlated with an unmet demand or need, the frequency of haplotypes for one or more genes in a first population having the unmet need or demand is compared with the frequency of such haplotypes in a second population that either lacks the same need or demand or in which existing products satisfy that need or demand. This frequency information may be obtained using any method known in the art, including those described or incorporated by reference herein, or may be obtained from a genomic data management company such as described herein. The genes evaluated may primarily be those that are candidate genes for the unmet need or demand, or may constitute all genes known to exist in the genome.

Any haplotype or combination of haplotypes that is significantly higher in the first population than in the second population is a haplotype profile that may be selected to evaluate in the next step of the method, which is identifying a functional cause for the correlation between that haplotype profile and the unmet need or demand. For example, where the unmet need is a disease that is not adequately treated by existing drugs in the first population, the functional cause may be a haplotype in the haplotype profile that defines an isoform of the target for the existing drugs that has poor binding characteristics for such existing drugs. Or, the functional cause may be a haplotype in the haplotype profile that causes the bearer of that haplotype to be a poor metabolizer of these existing drugs, which may lead to lack of efficacy and/or undesirable side effects.

Once the functional cause for the correlation between the haplotype profile and unmet need or demand is determined, a new product may be designed to overcome the functional cause. For example, if the functional cause is poor drug binding characteristics for the isoform of the drug target that is present in the first population, then new candidate compounds for treating the disease may be identified by screening against that isoform of the drug, or alternately, a different target and drug combination with potential efficacy in treating the disease may be sought. Similarly, if the functional cause is the presence of a “poor metabolizer haplotype” in the haplotype profile, a new candidate drug metabolized by another metabolic enzyme or via a different pathway may be evaluated for its ability to overcome this functional cause and thereby meet the unmet need or demand.

The invention further provides a method for marketing a drug for inclusion in a formulary controlled by a healthcare provider or healthcare payer. Nonlimiting examples of the healthcare provider and payer are hospitals and HMOs, respectively. In one embodiment, the method comprises identifying a haplotype profile that is correlated with a good therapeutic profile for the drug, determining the frequency of the haplotype profile in the population served by the formulary and making a marketing decision based on the determined frequency of the haplotype profile. In one embodiment, the marketing decision is to pursue inclusion in the formulary if the frequency of the haplotype profile indicates that a significant percentage of the population served by the formulary will exhibit a better response to the new drug than drugs currently in the market, which may include drugs already in the formulary.

In another embodiment, the invention provides a method for choosing a drug for inclusion in the formulary. This method comprises identifying a group of drugs that are prescribed to treat or alleviate the same medical condition, symptoms or disease, and determining for each drug a haplotype profile that is correlated with an acceptable therapeutic response profile for that drug. Then, the frequency of each of these haplotype profiles in the population served by the formulary is determined. A drug is chosen for the formulary based on the determined haplotype profile frequencies. For example, the drug whose correlated haplotype profile is the most frequent of the identified haplotype profiles may be the only drug from the group included in the formulary, or alternately, each drug in the group whose haplotype profile is present above a certain percentage in the population served by the formulary may be chosen.

It should be noted that many other embodiments are within the spirit of the invention and the preceding is only by way of example, and should not be construed to limit the invention to any of the specific details disclosed above.

1. A method for recruiting a new user for a genome management service, comprising:
obtaining a cell sample from a person;
waiting a period of time;
after the period of time has elapsed, seeking from the person final permission to have his or her genomic data managed;
analyzing at least a portion of the person's genome; and
storing the resultant genomic data electronically.

2. The method of claim 1 wherein said cell sample is obtained via a cheek swab.

3. The method of claim 1 wherein said sample is obtained in a mobile unit.

4. The method of claim 1 wherein said sample is obtained in a kiosk.

5. The method of claim 1 wherein said sample is obtained in a physician's office.

6. The method of claim 1 wherein said period of time is one week.

7. The method of claim 1 wherein the resultant genomic data is stored on a data card.

8. The method of claim 7 wherein said data card is kept by the user.

9. The method of claim 7 wherein said data card is the only location where said genomic data is stored.

10. The method of claim 1 wherein the genomic data is stored on a secure server.

11. A device for maintaining an individual's genomic data, comprising:
a data storage unit in which the individual's genomic data is stored; and
a self destruct unit, which deletes said data on said device when a trigger event occurs.

12. The device of claim 11, wherein said trigger event is an attempt to copy the data stored on said device.

13. The device of claim 11, wherein said trigger event is an unauthorized attempt to read data from the device.

14. The device of claim 11, wherein said data is stored in an encrypted format.

15. The device of claim 11, wherein said data storage device is kept by the individual.

16. A data card for maintaining an individual's genomic data, comprising a data storage unit in which the individual's genomic data is stored.

17. The data card of claim 16, further comprising a self-destruct unit, which deletes said data on said device when a trigger event occurs.

18. The data card of claim 17, wherein said trigger event is an attempt to copy the data stored on said device.

19. The data card of claim 17, wherein said trigger event is an unauthorized attempt to read data from the card.

20. The data card of claim 16, wherein said data is stored in an encrypted format.

21. The data card of claim 16, wherein said data card is kept by the individual.

22. A method for providing product usage advice for an individual, comprising:
receiving the individual's genomic data;
using said genomic data to consult a database or table, the database or table correlating genomic data with responses to products; and
creating a report containing product usage advice for one or more products.

23. The method of claim 22, wherein said correlations are obtained by using a computer program.

24. The method of claim 22, wherein said receiving further includes receiving any necessary additional information.

25. The method of claim 22, wherein said using step further includes consulting the database or table using additional information.

26. The method of claim 22, wherein said database or table further correlates additional information with responses to products.

27. The method of claim 22, further including the step of updating said report when said product is purchased.

28. The method of claim 22, wherein said receiving is performed in conjunction with a point of sale operation.

29. The method of claim 28, wherein said point of sale operation is a transaction using a data card.

30. The method of claim 28, wherein said point of sale operation is a transaction using a cash register.

31. The method of claim 28, wherein said point of sale operation is an online purchase.

32. The method of claim 22, wherein said product usage advice is a prediction of the individual's response to one or more products.

33. The method of claim 22, wherein said product usage advice is a dosage recommendation for one or more products.

34. The method of claim 22, wherein said product usage advice is a prediction of side effects for one or more products.

35. The method of claim 24, wherein said additional information includes a proposed usage suggestion for one or more products.

36. The method of claim 35, wherein said product usage advice is a prediction of the individual's response to the proposed product or products.

37. The method of claim 35, wherein product usage advice is a recommendation of one or more alternative products.

38. The method of claim 22 wherein said report is provided to the individual.

39. The method of claim 22 wherein said report is provided to a healthcare provided authorized by the individual.

40. The method of claim 22 wherein said report is provided to an expert assisting the individual, but the individual's genomic data is not.

41. The method of claim 22 wherein a fee is charged for each report created.

42. The method of claim 22, wherein said database or table correlates the individual's genomic data with a response to certain drugs.

43. The method of claim 22, additionally including the steps of:
receiving feedback concerning said individual's actual response to one or more of said products; and
updating said database or table based on said feedback.

44. A method for producing marketing data, comprising:
receiving from a group of individuals their genomic data;
receiving from said group of individuals data concerning their purchasing or consumption habits;
determining correlations between said genomic data and said purchasing or consumption habits; and
making a prediction concerning an individual's purchasing or consumption habits based on that individual's genomic data.

45. The method of claim 44, wherein said correlations are stored in a database or table.

46. The method of claim 44, wherein said correlations are obtained by using a computer program.

47. The method of claim 44, wherein said correlations are statistical.

48. The method of claim 44, wherein the said correlations contain no personally-identifying data related to said individuals.

49. The method of claim 44, with the additional step of selling said correlations to interested parties.

50. The method of claim 44, wherein members of said group are paid for their participation.

51. The method of claim 44, wherein said data concerning purchasing habits is received when a data card is used to make a purchase.

52. The method of claim 44, additionally including the steps of:
receiving feedback relating to the accuracy of said prediction and/or correlations; and
updating said prediction and/or correlations based on said feedback.

53. A method for marketing products to individuals based on their genomic data, comprising:
receiving from a group of individuals their genomic data;
receiving from said group of individuals data concerning their purchasing or consumption habits;
determining correlations between said genomic data and said purchasing or consumption habits;
making a prediction concerning an individual's purchasing or consumption habits based on that individual's genomic data; and
making a product suggestion.

54. The method of claim 53, wherein said correlations are stored in a database or table.

55. The method of claim 53, wherein said correlations are obtained by using a computer program.

56. The method of claim 53, wherein said correlations are statistical.

57. The method of claim 53, wherein the said correlations contain no personally-identifying data related to said individuals.

58. The method of claim 53, with the additional step of selling said correlations to interested parties.

59. The method of claim 53, with the additional step of selling said product suggestions to interested parties.

60. The method of claim 53, with the additional step of offering said product suggestions to said individuals.

61. The method of claim 53, wherein members of said group are paid for their participation.

62. The method of claim 53, wherein said data concerning purchasing habits is received when a data card is used to make a purchase.

63. The method of claim 53, additionally including the steps of:
receiving feedback relating to the appeal of the suggested product; and
updating said suggestion and/or correlations based on said feedback.

64. A method of providing a gaming experience to an individual based on his or her genomic data, comprising:
receiving the genomic data of said individual; and
affecting gameplay using said genomic data; whereby the individual's gaming experience is due at least in part to his or her genomic data.

65. The method of claim 64, wherein said affecting involves assigning the individual to a team.

66. The method of claim 64, wherein said affecting involves the manipulation of visual gameplay aspects.

67. The method of claim 64, wherein said affecting involves the manipulation of aural gameplay aspects.

68. The method of claim 64, wherein said affecting involves giving game characters strengths or weaknesses.

69. The method of claim 64, additionally including the steps of:
receiving feedback relating to said gaming experience; and
revising said affecting based on said feedback.

70. A method of providing an individual with lifestyle advice related to his or her genomic data, comprising:
using an individual's genomic data to consult a database or table which correlates genomic data with lifestyle advice; and
receiving, as a result of said consultation, said lifestyle advice.

71. The method of claim 70 wherein said correlations are obtained using a computer program.

72. The method of claim 70 wherein said genomic data is haplotypes or haplotype pairs.

73. The method of claim 70 wherein said lifestyle advice comprises recommendations on taking preventative steps against the onset of an illness.

74. The method of claim 70 wherein said lifestyle advice comprises diet recommendations.

75. The method of claim 70 wherein said lifestyle advice comprises exercise, recommendations.

76. The method of claim 70 wherein said lifestyle advice comprises information about unique genotypical aspects of the individual.

77. The method of claim 70, additionally including the step of providing the services of a genetic counselor to explain said lifestyle information.

78. The method of claim 70, additionally including the steps of:
receiving feedback relating to the accuracy of said lifestyle advice; and
updating said database or table based on said feedback.

79. A method of providing an individual with lifestyle advice related to his or her genomic data, comprising:
using an individual's genomic data to consult a database which correlates genomic data with information related to that genomic data;
receiving, as a result of said consultation, information related to said genomic data; and
providing lifestyle advice related to said information.

80. The method of claim 79 wherein said correlations are obtained using a computer program.

81. The method of claim 79 wherein said genomic data is haplotypes or haplotype pairs.

82. The method of claim 79 wherein said lifestyle advice comprises recommendations on taking preventative steps against the onset of an illness.

83. The method of claim 79 wherein said lifestyle advice comprises diet recommendations.

84. The method of claim 79 wherein said lifestyle advice comprises exercise recommendations.

85. The method of claim 79 wherein said lifestyle advice comprises information about unique genotypical aspects of the individual.

86. The method of claim 79, additionally including the step of providing the services of a genetic counselor to explain said lifestyle information.

87. The method of claim 79, additionally including the steps of:
receiving feedback relating to the accuracy of said lifestyle advice; and
updating said advice and/or said database or table based on said feedback.

88. A method of designing products based on an individual's genomic data, comprising:
obtaining the individual's genomic data; and
creating a design for said product based on said genomic data.

89. The method of claim 88 wherein said creating involves consulting a database or table which correlates certain genomic data with certain designs.

90. The method of claim 89, additionally including the steps of:
receiving feedback relating to the appeal of said design; and
updating said database or table based on said feedback.

91. The method of claim 88 wherein said creating involves using a computer program which correlates certain genomic data with certain designs.

92. The method of claim 91, additionally including the steps of:
receiving feedback relating to the appeal of said design; and
updating said computer program based on said feedback.

93. The method of claim 88 wherein said creating involves executing a design algorithm which takes said genomic data as an input.

94. The method of claim 93, additionally including the steps of:
receiving feedback relating to the appeal of said design; and
updating said algorithm based on said feedback.

95. The method of claim 88 wherein said product is a food.

96. The method of claim 88 wherein said product is artwork.

97. The method of claim 88 wherein said product is wearing apparel.

98. The method of claim 88 wherein said product is a perfume.

99. The method of claim 88 wherein said product is jewelry.

100. The method of claim 88 wherein said product is music.

101. A method for marketing an individual's genomic data, comprising:
contacting a party interested in using an individual's genomic data;
negotiating with the party to determine the terms of use for said data;
seeking the individual's consent to allow said party to use said data under the determined terms of use; and
if consent is received, providing, under the determined terms of use, said genomic data to said party.

102. The method of claim 101 wherein said providing is performed in such a manner that the party is not allowed to permanently keep said genomic data.

103. The method of claim 101 wherein said negotiations involves determining a price that said party will pay said individual for use of said genomic data.

104. The method of claim 101 wherein said negotiations involves determining the portions of the individual's genomic data that will be used by the party.

105. A method for providing an individual with low price genomic-based services, comprising:
receiving from the individual a request for a genomic-based service;
negotiating with a plurality of parties capable of providing said service in order to determine which party of said parties is willing to offer said service at a lower price than the remainder of said parties; and
upon receiving the individual's consent, allowing said party which offered said lower price to perform said service.

106. The method of claim 105 wherein said service is performing a medical test based on said individual's genomic data.

107. The method of claim 105 wherein said service is providing information based on said individual's genomic data.

108. The method of claim 105 wherein said service is providing artwork whose design is based on said individual's genomic data.

109. The method of claim 105, including the additional step of charging the individual a fee.

110. The method of claim 105, including the additional step of charging said service provider a fee.

111. The method of claim 105, wherein said negotiating step includes considering the quality of the providers.

112. The method of claim 111, wherein said receiving step further includes receiving from the individual quality requirements.

113. The method of claim 111, wherein the management company sets quality requirements.

114. A billing method for a genomic data managing service, comprising:
charging a management fee; and
charging a fee for each access of said data.

115. The method of claim 114, wherein said management fee is a periodic fee for maintaining said data.

116. The method of claim 115 wherein said periodic fee is a fee charged each time a predetermined interval elapses.

117. The method of claim 114, wherein said management fee is a fee for setting up a new account.

118. The method of claim 114, wherein said management fee is a fee for adding or deleting genomic data.

119. The method of claim 114, wherein said management fee is a fee for adding or deleting non-genomic data.

120. A method for providing an individual's genomic data to a party, comprising:
receiving from a party a request for an individual's genomic data;
negotiating with the party to determine the terms of use for said data;
seeking the individual's consent to allow said party to use said data under the determined terms of use; and
if consent is received, providing, under the determined terms of use, said genomic data to said party.

121. The method of claim 120 wherein said providing is performed in such a manner that the party is not allowed to hold or posses said genomic data.

122. The method of claim 120 wherein said negotiating involves determining a price that said party will pay said individual for use of said genomic data.

123. The method of claim 120 wherein said negotiating involves determining which portions of the individual's genomic data will be used by the party.

124. A method for securely transmitting an individual's genomic data to a party, comprising:
storing an individual's genomic data on a data card; and
physically transporting said data card to said party.

125. The method of claim 124, wherein said data card deletes the data it carries when a trigger event occurs.

126. The method of claim 125 wherein said trigger event is an attempt to read the data on the card using an incorrect decryption key.

127. The method of claim 125 wherein said trigger event is an attempt to use the data for a purpose other than the one agreed upon.

128. The method of claim 125 wherein said trigger event is the expiration of a count-down timer.

129. The method of claim 125 wherein said trigger event is said party failing to acknowledge receipt of said data.

130. The method of claim 124 wherein said data is stored in an encrypted manner.

131. A method for securely transmitting an individual's genomic data to a party, comprising:
creating a data package, said data package containing the individual's genomic data; and
allowing said party to download said package over a network.

132. The method of claim 131 wherein said package deletes the data it carries when a trigger event occurs.

133. The method of claim 132 wherein said trigger event is an attempt to read the data in the package using an incorrect decryption key.

134. The method of claim 132 wherein said trigger event is an attempt to use the data for a purpose other than the one agreed upon.

135. The method of claim 132 wherein said trigger event is the expiration of a count-down timer.

136. The method of claim 132 wherein said trigger event is said party failing to acknowledge receipt of said data.

137. The method of claim 131 wherein said package contains said data in an encrypted format.

138. The method of claim 131, wherein the party is selected from the group consisting of the individual, the individual's physician, the individual's genetic counselor, the individual's hospital, the individual's physician's office, the individual's pharmacy and the individual's pharmacist.

139. A system for providing product usage advice for an individual, comprising:
a memory having program code stored therein;
a database or table correlating genomic data with responses to products; and
a processor connected to said memory for carrying out instructions in accordance with said stored program code; wherein said program code, when executed by said processor, causes said processor to perform the steps of:
receiving the individual's genomic data;
using said genomic data to consult the database or table; and
creating a report containing product usage advice for one or more products.

140. The system of claim 139 wherein said correlations are obtained by using a computer program.

141. The system of claim 139, wherein said receiving further includes receiving any necessary additional information.

142. The system of claim 139, wherein said using step further includes consulting the database or table using additional information.

143. The system of claim 139, wherein said database or table further correlates additional information with responses to products.

144. The system of claim 139, further including the step of updating said report when said product is purchased.

145. The system of claim 139, wherein said receiving is performed in conjunction with a point of sale operation.

146. The system of claim 145, wherein said point of sale operation is a transaction using a data card.

147. The system of claim 145, wherein said point of sale operation is a transaction using a cash register.

148. The system of claim 145, wherein said point of sale operation is an online purchase.

149. The system of claim 139, wherein said product usage advice is a prediction of the individual's response to one or more products.

150. The system of claim 139, wherein said product usage advice is a dosage recommendation for one or more products.

151. The system of claim 139, wherein said product usage advice is a prediction of side effects for one or more products.

152. The system of claim 141, wherein said additional information includes a proposed usage suggestion for one or more products.

153. The system of claim 152, wherein said product usage advice is a prediction of the individual's response to the proposed product or products.

154. The system of claim 152, wherein product usage advice is a recommendation of one or more alternative products.

155. The system of claim 139 wherein said report is provided to the individual.

156. The system of claim 139 wherein said report is provided to an expert assisting the individual, but the individual's genomic data is not.

157. The system of claim 139 wherein a fee is charged for each report created.

158. The system of claim 139, wherein said database or table correlates haplotypes or haplotype pairs with a response to certain drugs.

159. The system of claim 139, additionally including the steps of:
receiving feedback concerning said individual's actual response to one or more of said products; and
updating said database or table based on said feedback.

160. A system for producing marketing data, comprising:
a memory having program code stored therein; and
a processor connected to said memory for carrying out instructions in accordance with said stored program code; wherein said program code, when executed by said processor, causes said processor to perform the steps of:
receiving from a group of individuals their genomic data;
receiving from said group of individuals data concerning their purchasing habits;
determining correlations between said genomic data and said purchasing habits; and
making a prediction concerning an individual's purchasing habits based on that individual's genomic data.

161. The system of claim 160 wherein said correlations are stored in a database or table.

162. The system of claim 160 wherein said correlations are obtained by using a computer program.

163. The system of claim 160, wherein said correlations are statistical.

164. The system of claim 160, wherein the said correlations contain no personally-identifying data related to said individuals.

165. The system of claim 160, with the additional step of selling said correlations to interested parties.

166. The system of claim 160, wherein members of said group are paid for their participation.

167. The system of claim 160, wherein said data concerning purchasing habits is received when a data card is used to make a purchase.

168. The system of claim 160, additionally including the steps of:
receiving feedback relating to the accuracy of said prediction and/or correlations; and
updating said prediction and/or correlations based on said feedback.

169. A system for marketing products to individuals based on their genomic data, comprising:
a memory having program code stored therein; and
a processor connected to said memory for carrying out instructions in accordance with said stored program code; wherein said program code, when executed by said processor, causes said processor to perform the steps of:
receiving from a group of individuals their genomic data;
receiving from said group of individuals data concerning their purchasing habits;
determining correlations between said genomic data and said purchasing habits;
making a prediction concerning an individual's purchasing habits based on that individual's genomic data; and
making a product suggestion.

170. The system of claim 169 wherein said correlations are stored in a database or table.

171. The system of claim 169 wherein said correlations are obtained by using a computer program.

172. The system of claim 169, wherein said correlations are statistical.

173. The system of claim 169, wherein the said correlations contain no personally-identifying data related to said individuals.

174. The system of claim 169, with the additional step of selling said correlations to interested parties.

175. The system of claim 169, with the additional step of selling said product suggestions to interested parties.

176. The system of claim 169, with the additional step of offering said product suggestions to said individuals.

177. The system of claim 169, wherein members of said group are paid for their participation.

178. The system of claim 169, wherein said data concerning purchasing habits is received when a data card is used to make a purchase.

179. The system of claim 169, additionally including the steps of:
receiving feedback relating to the appeal of the suggested product; and
updating said suggestion and/or correlations based on said feedback.

180. A system for providing a gaming experience to an individual based on his or her genomic data, comprising:
a memory having program code stored therein; and
a processor connected to said memory for carrying out instructions in accordance with said stored program code; wherein said program code, when executed by said processor, causes said processor to perform the steps of:
receiving the genomic data of said individual; and
affecting gameplay using said genomic data; whereby the individual's gaming experience is due at least in part to his or her genomic data.

181. The system of claim 180, wherein said affecting involves assigning the individual to a team.

182. The system of claim 180, wherein said affecting involves the manipulation of visual gameplay aspects.

183. The system of claim 180, wherein said affecting involves the manipulation of aural gameplay aspects.

184. The system of claim 180, wherein said affecting involves giving game characters strengths or weaknesses.

185. The system of claim 180, additionally including the steps of:
receiving feedback relating to said gaming experience; and
revising said affecting based on said feedback.

186. A system for providing an individual with lifestyle advice related to his or her genomic data, comprising:
a memory having program code stored therein;
a database or table correlating genomic data with lifestyle advice; and
a processor connected to said memory for carrying out instructions in accordance with said stored program code; wherein said program code, when executed by said processor, causes said processor to perform the steps of:
using the individual's genomic data to consult the database or table; and
receiving, as a result of said consultation, said lifestyle advice.

187. The system of claim 186, wherein said correlations are obtained using a computer program.

188. The system of claim 186, wherein said genomic data is haplotypes or haplotype pairs.

189. The system of claim 186, wherein said lifestyle advice comprises recommendations on taking preventative steps against the onset of an illness.

190. The system of claim 186, wherein said lifestyle advice comprises diet recommendations.

191. The system of claim 186, wherein said lifestyle advice comprises exercise recommendations.

192. The system of claim 186, wherein said lifestyle advice comprises information about unique genotypical aspects of the individual.

193. The system of claim 186, additionally including the step of providing the services of a genetic counselor to explain said lifestyle information.

194. The system of claim 186, additionally including the steps of:
receiving feedback relating to the accuracy of said lifestyle advice; and
updating said database or table based on said feedback.

195. A system for providing an individual with lifestyle advice related to his or her genomic data, comprising:
a memory having program code stored therein;
a database or table which correlates genomic data with information related to that genomic data; and
a processor connected to said memory for carrying out instructions in accordance with said stored program code; wherein said program code, when executed by said processor, causes said processor to perform the steps of:
using the individual's genomic data to consult the database or table;
receiving, as a result of said consultation, information related to said genomic data; and
providing lifestyle advice related to said information.

196. The system of claim 195, wherein said correlations are obtained using a computer program

197. The system of claim 195, wherein said genomic data is haplotypes or haplotype pairs.

198. The system of claim 195, wherein said lifestyle advice comprises recommendations on taking preventative steps against the onset of an illness.

199. The system of claim 195, wherein said lifestyle advice comprises diet recommendations.

200. The system of claim 195, wherein said lifestyle advice comprises exercise recommendations.

201. The system of claim 195, wherein said lifestyle advice comprises information about unique genotypical aspects of the individual.

202. The system of claim 195, additionally including the step of providing the services of a genetic counselor to explain said lifestyle information.

203. The system of claim 195, additionally including the steps of:
receiving feedback relating to the accuracy of said lifestyle advice; and
updating said advice and/or said database or table based on said feedback.

204. A system for designing products based on an individual's genomic data, comprising:
a memory having program code stored therein; and
a processor connected to said memory for carrying out instructions in accordance with said stored program code; wherein said program code, when executed by said processor, causes said processor to perform the steps of:
obtaining the individual's genomic data; and
creating a design for said product based on said genomic data.

205. The system of claim 204, wherein said creating involves consulting a database or table which correlates certain genomic data with certain designs.

206. The system of claim 205, additionally including the steps of:
receiving feedback relating to the appeal of said design; and
updating said database or table based on said feedback.

207. The system of claim 204, wherein said creating involves using a computer program which correlates certain genomic data with certain designs.

208. The system of claim 207, additionally including the steps of:
receiving feedback relating to the appeal of said design; and
updating said computer program based on said feedback.

209. The system of claim 204, wherein said creating involves executing a design algorithm which takes said genomic data as an input.

210. The system of claim 209, additionally including the steps of:
receiving feedback relating to the appeal of said design; and
updating said algorithm based on said feedback.

211. The system of claim 204, wherein said product is a food.

212. The system of claim 204, wherein said product is artwork.

213. The system of claim 204, wherein said product is wearing apparel.

214. The system of claim 204, wherein said product is a perfume.

215. The system of claim 204, wherein said product is jewelry.

216. The system of claim 204, wherein said product is music.

217. A system for marketing an individual's genomic data, comprising:
a memory having program code stored therein; and
a processor connected to said memory for carrying out instructions in accordance with said stored program code; wherein said program code, when executed by said processor, causes said processor to perform the steps of:
contacting a party interested in using an individual's genomic data;
negotiating with the party to determine the terms of use for said data;
seeking the individual's consent to allow said party to use said data under the determined terms of use; and
if consent is received, providing, under the determined terms of use, said genomic data to said party.

218. The system of claim 217 wherein said providing is performed in such a manner that the party is not allowed to permanently keep said genomic data.

219. The system of claim 217 wherein said negotiations involves determining a price that said party will pay said individual for use of said genomic data.

220. The system of claim 217 wherein said negotiations involves determining the portions of the individual's genomic data that will be used by the party.

221. A system for providing an individual with low price genomic-based services, comprising:
a memory having program code stored therein; and
a processor connected to said memory for carrying out instructions in accordance with said stored program code; wherein said program code, when executed by said processor, causes said processor to perform the steps of:
receiving from the individual a request for a genomic-based service;
negotiating with a plurality of parties capable of providing said service in order to determine which party of said parties is willing to offer said service at a lower price than the remainder of said parties; and
upon receiving the individual's consent, allowing said party which offered said lower price to perform said service.

222. The system of claim 221 wherein said service is performing a medical test based on said individual's genomic data.

223. The system of claim 221 wherein said service is providing information based on said individual's genomic data.

224. The system of claim 221 wherein said service is providing artwork whose design is based on said individual's genomic data.

225. The system of claim 221, including the additional step of charging the individual a fee.

226. The system of claim 221, including the additional step of charging said service provider a fee.

227. The system of claim 221, wherein said negotiating step includes considering the quality of the providers.

228. The system of claim 227, wherein said receiving step further includes receiving from the individual quality requirements.

229. The system of claim 227, wherein the management company sets quality requirements.

230. A billing system for a genomic data managing service, comprising:
a memory having program code stored therein; and
a processor connected to said memory for carrying out instructions in accordance with said stored program code; wherein said program code, when executed by said processor, causes said processor to perform the steps of:
charging a management fee; and
charging a fee for each access of said data.

231. The system of claim 230, wherein said management fee is a periodic fee for maintaining said data.

232. The system of claim 231, wherein said periodic fee is a fee charged each time a predetermined interval elapses.

233. The system of claim 230, wherein said management fee is a fee for setting up a new account.

234. The system of claim 230, wherein said management fee is a fee for adding or deleting genomic data.

235. The system of claim 230, wherein said management fee is a fee for adding or deleting non-genomic data.

236. A system for providing an individual's genomic data to a party, comprising:
a memory having program code stored therein; and
a processor connected to said memory for carrying out instructions in accordance with said stored program code;
wherein said program code, when executed by said processor, causes said processor to perform the steps of:
receiving from a party a request for an individual's genomic data;
negotiating with the party to determine the terms of use for said data;
seeking the individual's consent to allow said party to use said data under the determined terms of use; and
if consent is received, providing, under the determined terms of use, said genomic data to said party.

237. The system of claim 236, wherein said providing is performed in such a manner that the party is not allowed to hold or posses said genomic data.

238. The system of claim 236, wherein said negotiating involves determining a price that said party will pay said individual for 108 of said genomic data.

239. The system of claim 236, wherein said negotiating involves determining which portions of the individual's genomic data will be used by the party.

240. A system for securely transmitting an individual's genomic data to a party, comprising:
a memory having program code stored therein;
a data card interface; and
a processor connected to said memory for carrying out instructions in accordance with said stored program code; wherein said program code, when executed by said processor, causes said processor to perform the steps of:
storing an individual's genomic data on a data card; and
arranging for the physical transport of said data card to said party.

241. The system of claim 240, wherein said data card deletes the data it carries when a trigger event occurs.

242. The system of claim 241, wherein said trigger event is an attempt to read the data on the card using an incorrect decryption key.

243. The system of claim 241, wherein said trigger event is an attempt to use the data for a purpose other than the one agreed upon.

244. The system of claim 241, wherein said trigger event is the expiration of a count-down timer.

245. The system of claim 241, wherein said trigger event is said party failing to acknowledge receipt of said data.

246. The system of claim 241, wherein said data is stored in an encrypted manner.

247. A system for securely transmitting an individual's genomic data to a party, comprising:
a memory having program code stored therein; and
a processor connected to said memory for carrying out instructions in accordance with said stored program code; wherein said program code, when executed by said processor, causes said processor to perform the steps of:
creating a data package, said data package containing the individual's genomic data; and
allowing said party to download said package over a network.

248. The system of claim 247, wherein said package deletes the data it carries when a trigger event occurs.

249. The system of claim 248, wherein said trigger event is an attempt to read the data in the package using an incorrect decryption key.

250. The system of claim 248, wherein said trigger event is an attempt to use the data for a purpose other than the one agreed upon.

251. The system of claim 248, wherein said trigger event is the expiration of a count-down timer.

252. The system of claim 248, wherein said trigger event is said party failing to acknowledge receipt of said data.

253. The system of claim 247, wherein said package contains said data in an encrypted format.

254. A method for reimbursing a physician for the care of a patient comprising the steps of:
determining whether the physician prescribed a drug that the management company recommended for the patient based on the patient's therapeutic needs and the patient's genomic data; and
reimbursing the physician if the physician prescribed a recommended drug to the patient.

255. A method of marketing a product in a geographic region of interest, comprising:
obtaining information relating to correlations between users' response to the product and a haplotype profile;
determining the frequency of the haplotype profile in the population living in the geographic region; and
making a marketing decision for the geographic region based on the determined frequency of the haplotype profile.

256. The method of claim 255, wherein the product is a drug or biologic.

257. The method of claim 256, wherein the marketing decision is to proceed with marketing the product if the determined frequency of the haplotype profile is at least 25%.

258. The method of claim 256, wherein the marketing decision is to proceed with marketing the product if the determined frequency of the haplotype profile is at least 50%.

259. The method of claim 256, wherein the geographic region is a state or territory of the United States of America.

260. The method of claim 256, wherein the geographic region is a country.

261. A method for developing a new product to satisfy a particular unmet demand or need of a population, comprising:
identifying a haplotype profile that is correlated with the unmet demand or need in the population;
determining a functional cause for the correlation between the haplotype profile and the unmet need or demand; and
developing a new product designed to avoid the functional cause.

262. The method of claim 261, wherein the unmet demand or need is weight management.

263. The method of claim 261, wherein the unmet demand or need is addiction to smoking.

264. The method of claim 261, wherein the unmet demand or need is addiction to alcohol.

265. The method of claim 261, wherein the unmet demand or need is a treatment for schizophrenia.

266. The method of claim 261, wherein the unmet demand or need is a treatment for dyslipidemia.

267. The method of claim 261, wherein the unmet demand or need is a treatment for diabetes.

268. A method for marketing a drug for inclusion in a formulary, comprising:
identifying a haplotype profile that is correlated with a good therapeutic profile for the drug;
determining the frequency of the haplotype profile in the population served by the formulary; and
making a marketing decision based on the determined frequency of the haplotype profile.

269. The method of claim 168, wherein the marketing decision is to pursue inclusion in the formulary if the determined frequency of the haplotype profile is at least 25%.

270. A method for choosing a drug for inclusion in a formulary, comprising:
identifying a group of drugs that are prescribed to treat or alleviate the same medical condition, symptoms or disease;
obtaining for each drug a haplotype profile that is correlated with an acceptable therapeutic response profile for that drug; and
determining in the population served by the formulary the frequency of each obtained haplotype profile; and
chosing a drug for the formulary based on the determined haplotype profile frequencies.

271. The method of claim 271, wherein the chosing step comprises selecting the drug whose correlated haplotype profile has the highest frequency.

272. The method of claim 271, wherein the chosing step comprises selecting each drug whose correlated haplotype profile has a frequency greater than 25%.
